(19) United States
(12) Patent Application Publication
(10) Pub. No.: US 2026/0147201 A1
(43) Pub. Date: May 28, 2026

(54) OCULAR OPTICAL SYSTEM

(71) Applicant: GENIUS ELECTRONIC OPTICAL CO., LTD., Taichung City (TW)

(72) Inventors: Chun-Yang Huang, Taichung City (TW); Sheng-Wei Hsu, Taichung City (TW)

(73) Assignee: GENIUS ELECTRONIC OPTICAL CO., LTD., Taichung City (TW)

(21) Appl. No.: 19/015,638

(22) Filed: Jan. 10, 2025

(30) Foreign Application Priority Data
Nov. 26, 2024 (CN) 202411701651.3

(51) Int. Cl. G02B 25/00

(52) U.S. Cl. CPC G02B 25/001

(57) ABSTRACT

An ocular optical system is configured to allow an imaging ray from a display screen to enter an eye of an observer through the ocular optical system to form an image. The ocular optical system sequentially includes a first lens element and a second lens element along an optical axis from an eye side to a display side. The ocular optical system further includes a linear polarization film, a reflective polarization film, a quarter wave plate, and a partial mirror. The quarter wave plate is disposed on the reflective polarization film. The reflective polarization film is disposed on the linear polarization film. The linear polarization film is disposed on a plane of an optical axis region of the display-side surface of the first lens element. An optical axis region of the eye-side surface of the second lens element is a convex surface.

### CROSS-REFERENCE TO RELATED APPLICATION

This application claims the priority benefit of China application serial no. 202411701651.3, filed on Nov. 26, 2024. The entirety of the above-mentioned patent application is hereby incorporated by reference herein and made a part of this specification.

### BACKGROUND

### Technical Field

The disclosure relates to an optical system, and in particular to an ocular optical system.

### Related Art

On the market, the ocular optical system for the VR application may be mainly divided into three categories: an aspherical optical element, a Fresnel optical element, and a pancake optical element. The aspherical optical element has advantages of low manufacturing cost and fewer stray light problems such as flare and ghost, but the aspherical optical element is heavy and bulky. The Fresnel optical element has advantages of lightweight and an increased half field of view, but the manufacturing cost of the Fresnel optical element is higher than the manufacturing cost of the aspherical optical element. In addition, the Fresnel optical element has a disadvantage of a serious flare problem. The pancake optical element has advantages of the weight and volume less than half of the weight and volume of the aspherical optical element, and no flare problem. However, since the cost of the material of the optical film accounts for half of the cost of the lens, plus the high difficulty in film attachment process, assembly precision, and calibration, the manufacturing cost of the pancake optical element is about 10 to 40 times the manufacturing cost of the aspherical optical element, which easily causes a ghost problem.

Based on the above, with the advantage of lightweight, the pancake optical element has become the mainstream development in the industry at present, but has lower production yield and higher cost. Therefore, how to solve the aforementioned problems is one of the directions for research and development in the industry. In addition, how to increase the half field of view, make the weight of the ocular optical system light, and improve the image quality are issues to be improved.

### SUMMARY

The disclosure provides an ocular optical system which may satisfy demands of a consumer for image quality and magnification and may also reduce a weight and volume of the ocular optical system, thereby reducing manufacturing cost of the ocular optical system.

The disclosure provides an ocular optical system, configured to allow an imaging ray from a display screen to enter an eye of an observer through the ocular optical system to form an image, where a side toward the eye is an eye side, and a side toward the display screen is a display side. The ocular optical system sequentially includes a first lens element and a second lens element along an optical axis from the eye side to the display side. The first lens element to the second lens element each includes an eye-side surface facing the eye side and allowing the imaging ray to pass and a display-side surface facing the display side and allowing the imaging ray to pass. The ocular optical system further includes a linear polarization film, a reflective polarization film, a quarter wave plate, and a partial mirror. The quarter wave plate is disposed on the reflective polarization film. The reflective polarization film is disposed on the linear polarization film. The linear polarization film is disposed on a plane of an optical axis region of the display-side surface of the first lens element. An optical axis region of the eye-side surface of the second lens element is a convex surface. The ocular optical system satisfies following conditional expressions: TTL/BFL≤8.200 and ImgH/(T1+G12)≥2.900, where TTL is a distance from the eye-side surface of the first lens element to the display screen on the optical axis, BFL is a distance from the display-side surface of the second lens element to the display screen on the optical axis, ImgH is a maximum image height of the ocular optical system, T1 is a thickness of the first lens element on the optical axis, and G12 is a distance from the display-side surface of the first lens element to the eye-side surface of the second lens element on the optical axis.

The disclosure further provides an ocular optical system, configured to allow an imaging ray from a display screen to enter an eye of an observer through the ocular optical system to form an image, where a side toward the eye is an eye side, and a side toward the display screen is a display side. The ocular optical system sequentially includes a first lens element and a second lens element along an optical axis from the eye side to the display side. The first lens element to the second lens element each includes an eye-side surface facing the eye side and allowing the imaging ray to pass and a display-side surface facing the display side and allowing the imaging ray to pass. The ocular optical system further includes a linear polarization film, a reflective polarization film, a quarter wave plate, and a partial mirror. The quarter wave plate is disposed on the reflective polarization film. The reflective polarization film is disposed on the linear polarization film. The linear polarization film is disposed on a plane of an optical axis region of the display-side surface of the first lens element. An optical axis region of the eye-side surface of the second lens element is a convex surface. The ocular optical system satisfies following conditional expressions: 2.100≤TTL/BFL≤8.200 and (ImgH+BFL)/(T1+G12)≥3.200, where TTL is a distance from the eye-side surface of the first lens element to the display screen on the optical axis, BFL is a distance from the display-side surface of the second lens element to the display screen on the optical axis, ImgH is a maximum image height of the ocular optical system, T1 is a thickness of the first lens element on the optical axis, and G12 is a distance from the display-side surface of the first lens element to the eye-side surface of the second lens element on the optical axis.

The disclosure further provides an ocular optical system, configured to allow an imaging ray from a display screen to enter an eye of an observer through the ocular optical system to form an image, where a side toward the eye is an eye side, and a side toward the display screen is a display side. The ocular optical system sequentially includes a first lens element and a second lens element along an optical axis from the eye side to the display side. The first lens element to the second lens element each includes an eye-side surface facing the eye side and allowing the imaging ray to pass and a display-side surface facing the display side and allowing the imaging ray to pass. The ocular optical system further includes a linear polarization film, a reflective polarization film, a quarter wave plate, and a partial mirror. The optical axis region of the display-side surface of the first lens element is a plane. The optical axis region of the eye-side surface of the second lens element is a convex surface. A peripheral region of the eye-side surface of the second lens element is a concave surface. The ocular optical system satisfies a following conditional expression: (ImgH+BFL)/(T1+G12)≥3.500, where ImgH is a maximum image height of the ocular optical system, BFL is a distance from the display-side surface of the second lens element to the display screen on the optical axis, T1 is a thickness of the first lens element on the optical axis, and G12 is a distance from the display-side surface of the first lens element to the eye-side surface of the second lens element on the optical axis.

Based on the above, beneficial effects of the ocular optical system according to the embodiments of the disclosure are as follows: by satisfying the conditions of optical design, and disposing the polarization film, the reflective polarization film, and the quarter wave plate all on the plane of the display-side surface of the first lens element, it is beneficial to reduce the film attachment process to lower manufacturing cost, contributing to the lightweight design of the ocular optical system. Moreover, when the optical axis region of the eye-side surface of the second lens element is a convex surface, the incident light ray may effectively converge. Additionally, disposing a partial mirror on the display-side surface of the second lens element is also beneficial to increase the half field of view according to principles of reflection and polarization and satisfy a demand of the consumer for a wide field of view of the image screen.

To make the aforementioned features and advantages of the disclosure comprehensible, embodiments are described below in detail with reference to the accompanying drawings.

### BRIEF DESCRIPTION OF THE DRAWINGS

FIG. 1 is a schematic diagram illustrating an imaging ray emitted from a display screen entering an eye through an ocular optical system.

FIG. 2 is a schematic diagram illustrating a surface structure of a lens element.

FIG. 3 is a schematic diagram illustrating a concave-convex surface structure of a lens element and intersection points of a ray.

FIG. 4 is a schematic diagram illustrating a surface structure of a lens element in Example 1.

FIG. 5 is a schematic diagram illustrating a surface structure of a lens element in Example 2.

FIG. 6 is a schematic diagram illustrating a surface structure of a lens element in Example 3.

FIG. 7 is a schematic diagram of an ocular optical system according to the first embodiment of the disclosure.

FIG. 8A to FIG. 8D are diagrams of longitudinal spherical aberrations and various aberrations of the ocular optical system according to the first embodiment.

FIG. 9 shows detailed optical data of the ocular optical system according to the first embodiment of the disclosure.

FIG. 10 shows aspheric parameters of the ocular optical system according to the first embodiment of the disclosure.

FIG. 11 is a schematic diagram of an ocular optical system according to the second embodiment of the disclosure.

FIG. 12A to FIG. 12D are diagrams of longitudinal spherical aberrations and various aberrations of the ocular optical system according to the second embodiment.

FIG. 13 shows detailed optical data of the ocular optical system according to the second embodiment of the disclosure.

FIG. 14 shows aspheric parameters of the ocular optical system according to the second embodiment of the disclosure.

FIG. 15 is a schematic diagram of an ocular optical system according to the third embodiment of the disclosure.

FIG. 16A to FIG. 16D are diagrams of longitudinal spherical aberrations and various aberrations of the ocular optical system according to the third embodiment.

FIG. 17 shows detailed optical data of the ocular optical system according to the third embodiment of the disclosure.

FIG. 18 shows aspheric parameters of the ocular optical system according to the third embodiment of the disclosure.

FIG. 19 is a schematic diagram of an ocular optical system according to the fourth embodiment of the disclosure.

FIG. 20A to FIG. 20D are diagrams of longitudinal spherical aberrations and various aberrations of the ocular optical system according to the fourth embodiment.

FIG. 21 shows detailed optical data of the ocular optical system according to the fourth embodiment of the disclosure.

FIG. 22 shows aspheric parameters of the ocular optical system according to the fourth embodiment of the disclosure.

FIG. 23 is a schematic diagram of an ocular optical system according to the fifth embodiment of the disclosure.

FIG. 24A to FIG. 24D are diagrams of longitudinal spherical aberrations and various aberrations of the ocular optical system according to the fifth embodiment.

FIG. 25 shows detailed optical data of the ocular optical system according to the fifth embodiment of the disclosure.

FIG. 26 shows aspheric parameters of the ocular optical system according to the fifth embodiment of the disclosure.

FIG. 27 is a schematic diagram of an ocular optical system according to the sixth embodiment of the disclosure.

FIG. 28A to FIG. 28D are diagrams of longitudinal spherical aberrations and various aberrations of the ocular optical system according to the sixth embodiment.

FIG. 29 shows detailed optical data of the ocular optical system according to the sixth embodiment of the disclosure.

FIG. 30 shows aspheric parameters of the ocular optical system according to the sixth embodiment of the disclosure.

FIG. 31 is a schematic diagram of an ocular optical system according to the seventh embodiment of the disclosure.

FIG. 32A to FIG. 32D are diagrams of longitudinal spherical aberrations and various aberrations of the ocular optical system according to the seventh embodiment.

FIG. 33 shows detailed optical data of the ocular optical system according to the seventh embodiment of the disclosure.

FIG. 34 shows aspheric parameters of the ocular optical system according to the seventh embodiment of the disclosure.

FIG. 35 to FIG. 37 show numerical values of relational expressions for various important parameters of the ocular optical systems according to the first to seventh embodiments of the disclosure.

### DESCRIPTION OF THE EMBODIMENTS

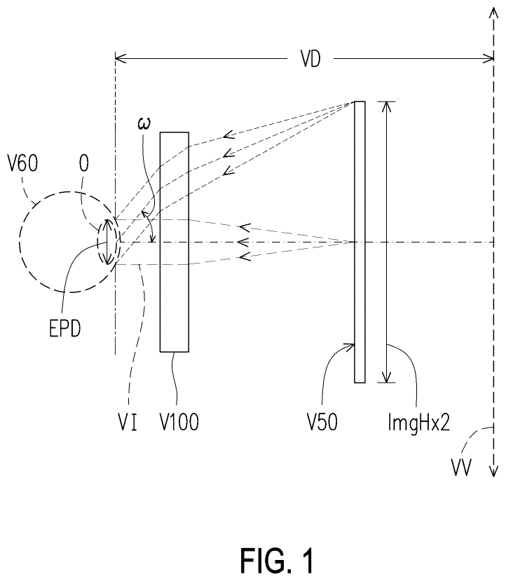

In general, a ray direction of an ocular optical system V100 refers to the following: imaging rays VI are emitted by a display screen V50, enter an eye V60 via the ocular optical system V100, and are then focused on a retina of the eye V60 for imaging and generating an enlarged virtual image VV at a least distance of distinct vision VD, as depicted in FIG. 1. The following criteria for determining optical specifications of the present application are based on assumption that a reversely tracking of the ray direction is parallel imaging rays passing through the ocular optical system from an eye-side and focused on the display screen for imaging.

The terms “optical axis region”, “periphery region”, “concave”, and “convex” used in this specification and claims should be interpreted based on the definition listed in the specification by the principle of lexicographer.

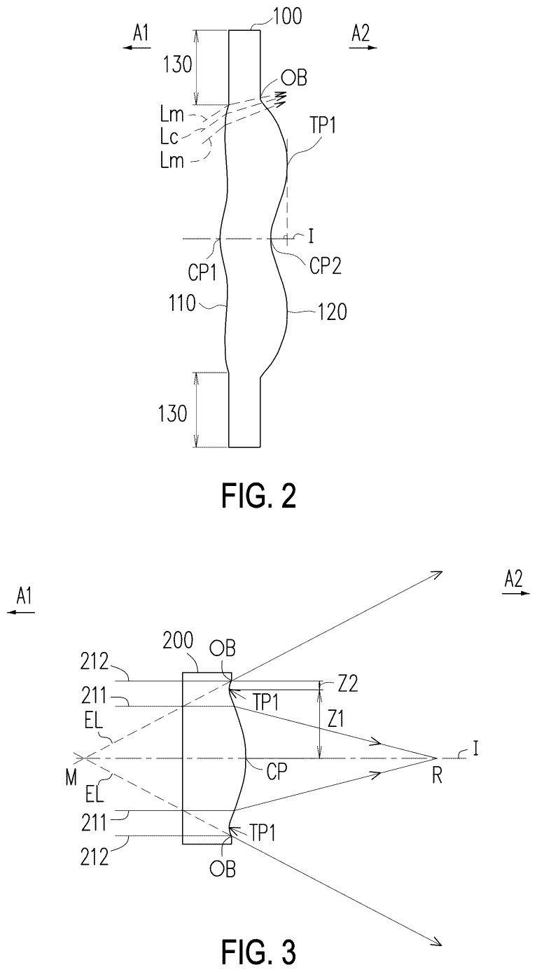

In the present disclosure, the optical system may comprise at least one lens element to receive imaging rays that are incident on the optical system over a set of angles ranging from parallel to an optical axis to a half field of view (HFOV) angle with respect to the optical axis. The imaging rays pass through the optical system to produce an image on an image plane. The term “a lens element having positive refracting power (or negative refracting power)” means that the paraxial refracting power of the lens element in Gaussian optics is positive (or negative). The term “an eye-side (or display-side) surface of a lens element” refers to a specific region of that surface of the lens element at which imaging rays can pass through that specific region. Imaging rays include at least two types of rays: a chief ray Lc and a marginal ray Lm (as shown in FIG. 2). An eye-side (or display-side) surface of a lens element can be characterized as having several regions, including an optical axis region, a periphery region, and, in some cases, one or more intermediate regions, as discussed more fully below.

FIG. 2 is a radial cross-sectional view of a lens element 100. Two referential points for the surfaces of the lens element 100 can be defined: a central point, and a transition point. The central point of a surface of a lens element is a point of intersection of that surface and the optical axis I. As illustrated in FIG. 2, a first central point CP1 may be present on the eye-side surface 110 of lens element 100 and a second central point CP2 may be present on the display-side surface 120 of the lens element 100. The transition point is a point on a surface of a lens element, at which the line tangent to that point is perpendicular to the optical axis I. The optical boundary OB of a surface of the lens element is defined as a point at which the radially outermost marginal ray Lm passing through the surface of the lens element intersects the surface of the lens element. All transition points lie between the optical axis I and the optical boundary OB of the surface of the lens element. A surface of the lens element 100 may have no transition point or have at least one transition point. If multiple transition points are present on a single surface, then these transition points are sequentially named along the radial direction of the surface with reference numerals starting from the first transition point. For example, the first transition point, e.g., TP1, (closest to the optical axis I), the second transition point, e.g., TP2, (as shown in FIG. 5), and the Nth transition point (farthest from the optical axis I).

When a surface of the lens element has at least one transition point, the region of the surface of the lens element from the central point to the first transition point TP1 is defined as the optical axis region, which includes the central point. The region located radially outside of the farthest transition point (the Nth transition point) from the optical axis I to the optical boundary OB of the surface of the lens element is defined as the periphery region. In some embodiments, there may be intermediate regions present between the optical axis region and the periphery region, with the number of intermediate regions depending on the number of the transition points. When a surface of the lens element has no transition point, the optical axis region is defined as a region of 0%-50% of the distance between the optical axis I and the optical boundary OB of the surface of the lens element, and the periphery region is defined as a region of 50%-100% of the distance between the optical axis I and the optical boundary OB of the surface of the lens element.

The shape of a region is convex if a collimated ray being parallel to the optical axis I and passing through the region is bent toward the optical axis I such that the ray intersects the optical axis I on the display side A2 of the lens element. The shape of a region is concave if the extension line of a collimated ray being parallel to the optical axis I and passing through the region intersects the optical axis I on the eye side A1 of the lens element.

Additionally, referring to FIG. 2, the lens element 100 may also have a mounting portion 130 extending radially outward from the optical boundary OB. The mounting portion 130 is typically used to physically secure the lens element to a corresponding element of the optical system (not shown). Imaging rays do not reach the mounting portion 130. The structure and shape of the mounting portion 130 are only examples to explain the technologies, and should not be taken as limiting the scope of the present disclosure. The mounting portion 130 of the lens elements discussed below may be partially or completely omitted in the following drawings.

Referring to FIG. 3, optical axis region Z1 is defined between central point CP and first transition point TP1. Periphery region Z2 is defined between TP1 and the optical boundary OB of the surface of the lens element. Collimated ray 211 intersects the optical axis I on the display side A2 of lens element 200 after passing through optical axis region Z1, i.e., the focal point of collimated ray 211 after passing through optical axis region Z1 is on the display side A2 of the lens element 200 at point R in FIG. 3. Accordingly, since the ray itself intersects the optical axis I on the display side A2 of the lens element 200, optical axis region Z1 is convex. On the contrary, collimated ray 212 diverges after passing through periphery region Z2. The extension line EL of collimated ray 212 after passing through periphery region Z2 intersects the optical axis I on the eye side A1 of lens element 200, i.e., the focal point of collimated ray 212 after passing through periphery region Z2 is on the eye side A1 at point M in FIG. 3. Accordingly, since the extension line EL of the ray intersects the optical axis I on the eye side A1 of the lens element 200, periphery region Z2 is concave. In the lens element 200 illustrated in FIG. 3, the first transition point TP1 is the border of the optical axis region and the periphery region, i.e., TP1 is the point at which the shape changes from convex to concave.

Alternatively, there is another way for a person having ordinary skill in the art to determine whether an optical axis region is convex or concave by referring to the sign of “Radius of curvature” (the “R” value), which is the paraxial radius of shape of a lens surface in the optical axis region. The R value is commonly used in conventional optical design software such as Zemax and CodeV. The R value usually appears in the lens data sheet in the software. For an eye-side surface, positive R value defines that the optical axis region of the eye-side surface is convex, and negative R value defines that the optical axis region of the eye-side surface is concave. Conversely, for a display-side surface, positive R value defines that the optical axis region of the display-side surface is concave, and negative R value defines that the optical axis region of the display-side surface is convex. The result found by using this method should be consistent with the method utilizing intersection of the optical axis by rays/extension lines mentioned above, which determines surface shape by referring to whether the focal point of a collimated ray being parallel to the optical axis I is on the eye-side or the display-side of a lens element. As used herein, the terms “a shape of a region is convex (concave),” “a region is convex (concave),” and “a convex-(concave-) region,” can be used alternatively.

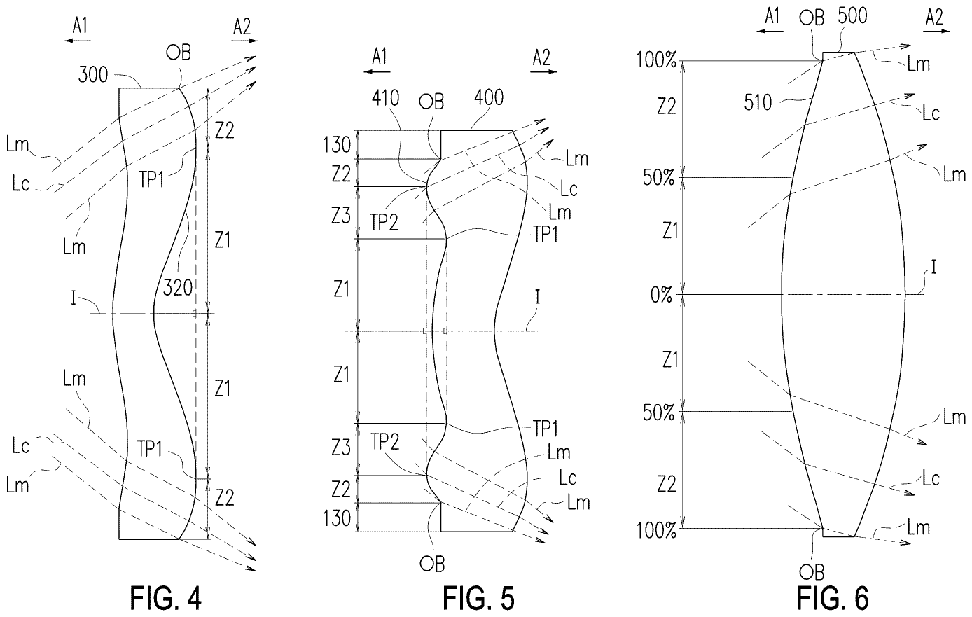

FIG. 4, FIG. 5, and FIG. 6 illustrate examples of determining the shape of lens element regions and the boundaries of regions under various circumstances, including the optical axis region, the periphery region, and intermediate regions as set forth in the present specification.

FIG. 4 is a radial cross-sectional view of a lens element 300. As illustrated in FIG. 4, only one transition point TP1 appears within the optical boundary OB of the display-side surface 320 of the lens element 300. Optical axis region Z1 and periphery region Z2 of the display-side surface 320 of lens element 300 are illustrated. The R value of the display-side surface 320 is positive (i.e., R>0). Accordingly, the optical axis region Z1 is concave.

In general, the shape of each region demarcated by the transition point will have an opposite shape to the shape of the adjacent region(s). Accordingly, the transition point will define a transition in shape, changing from concave to convex at the transition point or changing from convex to concave. In FIG. 4, since the shape of the optical axis region Z1 is concave, the shape of the periphery region Z2 will be convex as the shape changes at the transition point TP1.

FIG. 5 is a radial cross-sectional view of a lens element 400. Referring to FIG. 5, a first transition point TP1 and a second transition point TP2 are present on the eye-side surface 410 of lens element 400. The optical axis region Z1 of the eye-side surface 410 is defined between the optical axis I and the first transition point TP1. The R value of the eye-side surface 410 is positive (i.e., R>0). Accordingly, the optical axis region Z1 is convex.

The periphery region Z2 of the eye-side surface 410, which is also convex, is defined between the second transition point TP2 and the optical boundary OB of the eye-side surface 410 of the lens element 400. Further, intermediate region Z3 of the eye-side surface 410, which is concave, is defined between the first transition point TP1 and the second transition point TP2. Referring once again to FIG. 5, the eye-side surface 410 includes an optical axis region Z1 located between the optical axis I and the first transition point TP1, an intermediate region Z3 located between the first transition point TP1 and the second transition point TP2, and a periphery region Z2 located between the second transition point TP2 and the optical boundary OB of the eye-side surface 410. Since the shape of the optical axis region Z1 is designed to be convex, the shape of the intermediate region Z3 is concave as the shape of the intermediate region Z3 changes at the first transition point TP1, and the shape of the periphery region Z2 is convex as the shape of the periphery region Z2 changes at the second transition point TP2.

FIG. 6 is a radial cross-sectional view of a lens element 500. Lens element 500 has no transition point on the eye-side surface 510 of the lens element 500. For a surface of a lens element with no transition point, for example, the eye-side surface 510 the lens element 500, the optical axis region Z1 is defined as the region of 0%-50% of the distance between the optical axis I and the optical boundary OB of the surface of the lens element and the periphery region is defined as the region of 50%-100% of the distance between the optical axis I and the optical boundary OB of the surface of the lens element. Referring to lens element 500 illustrated in FIG. 6, the optical axis region Z1 of the eye-side surface 510 is defined between the optical axis I and 50% of the distance between the optical axis I and the optical boundary OB. The R value of the eye-side surface 510 is positive (i.e., R>0). Accordingly, the optical axis region Z1 is convex. For the eye-side surface 510 of the lens element 500, because there is no transition point, the periphery region Z2 of the eye-side surface 510 is also convex. It should be noted that lens element 500 may have a mounting portion (not shown) extending radially outward from the periphery region Z2.

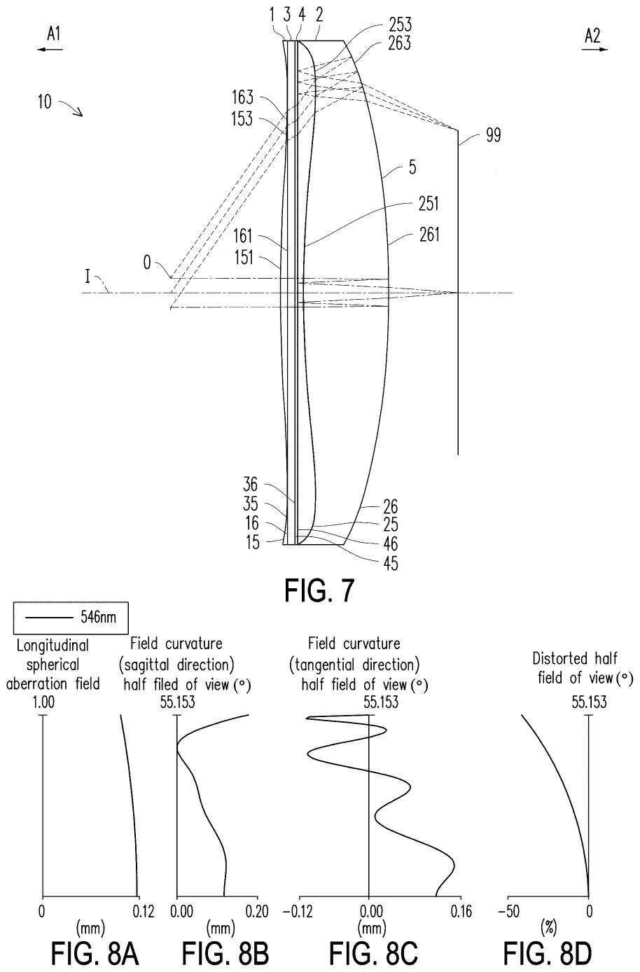

FIG. 7 is a schematic diagram of an ocular optical system according to the first embodiment of the disclosure. FIG. 8A to FIG. 8D are diagrams of longitudinal spherical aberrations and various aberrations of the ocular optical system according to the first embodiment. Referring to FIG. 7 first, an ocular optical system 10 of the first embodiment of the disclosure sequentially includes, a first lens element 1, a polarization film plus a reflective polarization film 3, a quarter wave plate 4, a second lens element 2, and a partial mirror 5 along an optical axis I of the ocular optical system 10 from the eye side A1 to the display side A2. When the ray emitted from a display screen (such as a display screen 99 shown in FIG. 7) to enter an eye (such as a pupil 0 of the observer shown in FIG. 7) through the ocular optical system 10 to form an image, this image is a magnified virtual image.

In this embodiment, the first lens element 1, the second lens element 2, the linear polarization film plus the reflective polarization film 3, and the quarter wave plate 4 each has eye-side surfaces 15, 25, 35, and 45 facing the eye side A1 and allowing the imaging ray to pass and display-side surfaces 16, 26, 36, and 46 facing the display side A2 and allowing the imaging ray to pass. In this embodiment, the first lens element 1 is disposed between the pupil 0 and the second lens element 2.

The first lens element 1 has positive refractive power. An optical axis region 151 and a periphery region 153 of the eye-side surface 15 of the first lens element 1 are both convex surfaces. An optical axis region 161 and a periphery region 163 of the display-side surface 16 of the first lens element 1 are both planes.

The second lens element 2 has positive refractive power. An optical axis region 251 of the eye-side surface 25 of the second lens element 2 is a convex surface, and a periphery region 253 thereof is a concave surface. An optical axis region 261 and a periphery region 263 of the display-side surface 26 of the second lens element 2 are both convex surfaces.

The reflective polarization film is disposed on the linear polarization film, and are together represented as the linear polarization film plus the reflective polarization film 3 in subsequent figures. The linear polarization film is disposed on a plane of the optical axis region 161 of the display-side surface 16 of the first lens element 1, to reflect an imaging ray in a linear polarization state and allow an imaging ray in another linear polarization state to pass. Specifically, the linear polarization film plus the reflective polarization film 3 may be directly disposed on the entire display-side surface 16 of the first lens element 1.

The quarter wave plate 4 is disposed on the reflective polarizing film, specifically in a direction of the optical axis I. The quarter wave plate 4 is disposed between the linear polarization film plus the reflective polarization film 3 and the second lens element 2. The quarter wave plate 4 is configured to convert an imaging ray in a circular polarization state to the imaging ray in the linear polarization state, or convert the imaging ray in a linear polarization state to the imaging ray in the circular polarization state. Specifically, the quarter wave plate 4 is disposed between the display-side surface 16 of the first lens element 1 and the eye-side surface 25 of the second lens element 2.

A partial mirror 5 is disposed on the display-side surface 26 of the second lens element 2, and is configured to reflect partial energy of the imaging ray. Further, in this embodiment, the partial mirror 5 is disposed on the optical axis region 261 of the display-side surface 26 of the second lens element 2, but the disclosure is not limited to thereto. The partial mirror 5 has an average optical reflectivity of at least 30% in the expected multiple wavelengths, and in this embodiment, the partial mirror 5 is a half-mirror.

In this embodiment, the eye-side surfaces 15 and 25 and the display-side surface 26 are all aspheric surfaces. The partial mirror 5 disposed on the display-side surface 26 is substantially conformally disposed with the display-side surface 26, so the partial mirror 5 may also be aspheric. In other words, the eye-side surfaces 15 and 25 and the display-side surface 26 may all be aspheric surfaces.

Specifically, in this embodiment, the display screen (as shown in the display screen 99 in FIG. 7) provides the imaging ray in one of the circular polarization states which passes the second lens element 2 to the quarter wave plate 4 to form the imaging ray in one of the linear polarization states. The imaging ray in the one of the linear polarization states is transmitted to the polarization film plus reflective polarization film 3, and reflected as imaging rays in the one of the linear polarization states. The imaging ray in the one of the linear polarization states pass the quarter wave plate 4 again to form the imaging ray in another one of the circular polarization states. After passing the second lens element 2, the imaging ray in the another one of the circular polarization states is transmitted to the display-side surface 26 of the second lens element 2 including the partial mirror 5 to reflect the imaging ray in the another one of the circular polarization states. After passing the second lens element 2 again, the imaging ray in the another one of the circular polarization states is transmitted to the quarter wave plate 4 to form the imaging ray in another one of the linear polarization states. Finally, after passing the polarization film plus the reflective polarization film 3, the imaging ray in the another one of the linear polarization states is transmitted to the first lens element 1 to enter the eye of the observer (as shown in the pupil 0 of the observer in FIG. 7) to form a magnified virtual image.

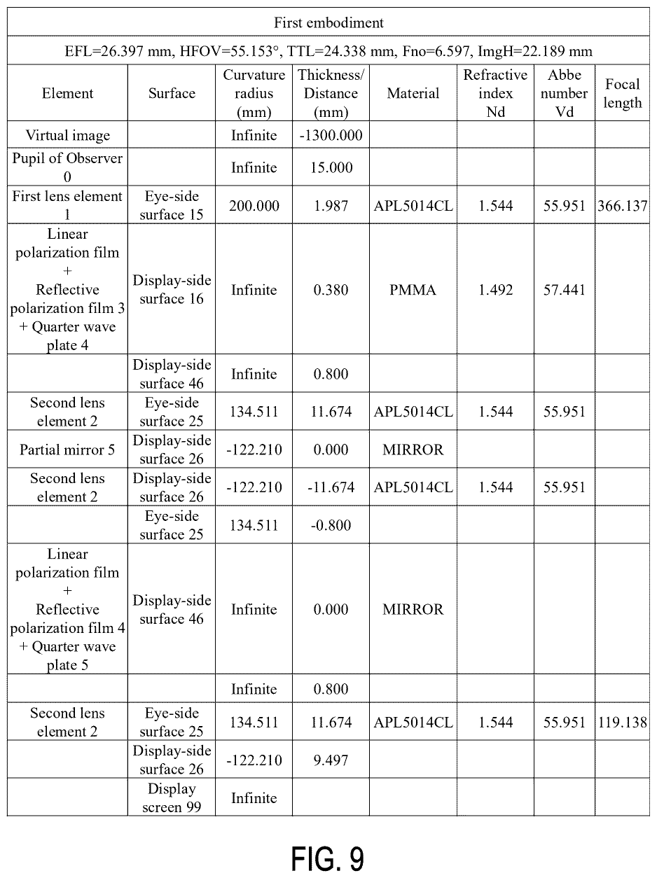

Other detailed optical data of the first embodiment is shown in FIG. 9. An effective focal length (EFL) of the ocular optical system 10 of the first embodiment is 26.397 mm, a half field of view (HFOV) is 55.153 degrees, TTL is 24.338 mm, a F-number (Fno) is 6.597, and a maximum image height (ImgH) is 22.189 mm, where TTL refers to a distance from the eye-side surface 11 of the first lens element 1 to the display screen 99 on the optical axis I. It is worth mentioning that in FIG. 9 and the subsequent embodiments, thicknesses or distances in the tables have directionality, where a direction of the ray toward the eye side A1 is defined as positive, and a direction of the ray toward the display side A2 is defined as negative.

Moreover, in this embodiment, the aspheric eye-side surfaces 15 and 25 and the display-side surface 26 are general even aspheric surfaces. These aspheric surfaces are defined according to the following formula (1):

$$Z ( Y ) = \frac{{Y}^{2}}{R} / ( 1 + \sqrt{1 - ( 1 + K ) \frac{{Y}^{2}}{{R}^{2}}} ) + {\sum }_{i = 1}^{n} {a}_{i} \times {Y}^{i} \qquad ( 1 )$$

Where:
R is a curvature radius of a lens element surface near the optical axis I.
Z is a depth of the aspheric surface (a vertical distance between a point whose distance to the optical axis I is Y on the aspheric surface and a tangent plane tangent to an apex of the aspheric surface in the optical axis I).
Y is a vertical distance between a point on the aspheric surface and the optical axis I.
K is a conic constant.
aᵢ is an i^{th} aspheric surface coefficient.

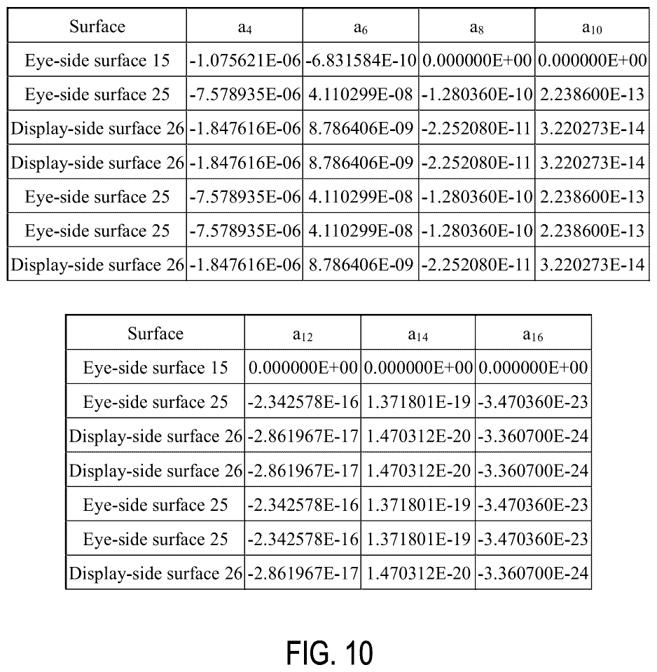

Aspheric coefficients for the eye-side surface and the display-side surface of each element mentioned above are shown in FIG. 10. In this embodiment and the following embodiments, the conic constant and the 2^{nd} order aspheric coefficient a₂ are both 0. Therefore, the representation of the conic constant and the spherical coefficient a₂ is omitted in the table.

Moreover, a definition of an “inflection point” of the aforementioned aspheric surfaces is as follows: after the second derivative of the function Z(Y) in formula (1) is taken, the Y value is found when the second derivative of the function Z(Y) equals 0. A point at a position of the Y value is an inflection point. In other words, this inflection point is a point on the aspheric surface, and a distance from the optical axis I is the Y value.

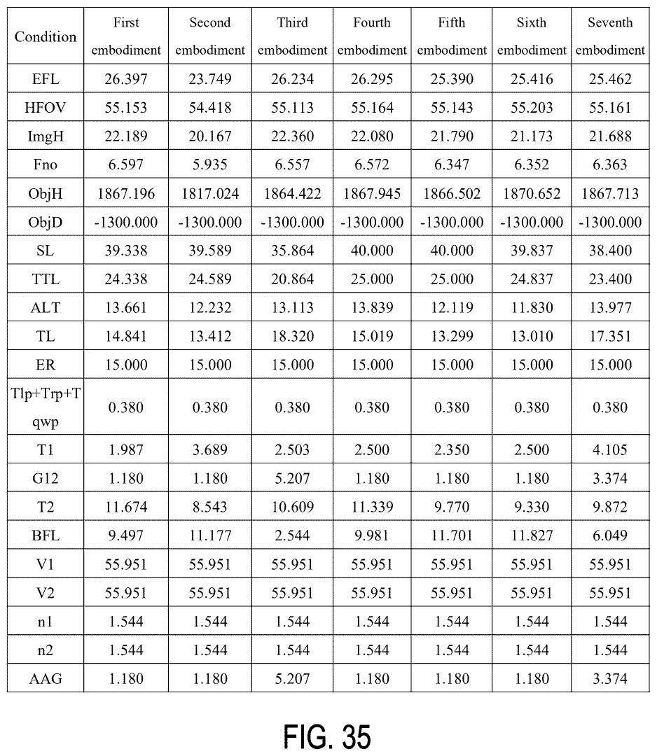

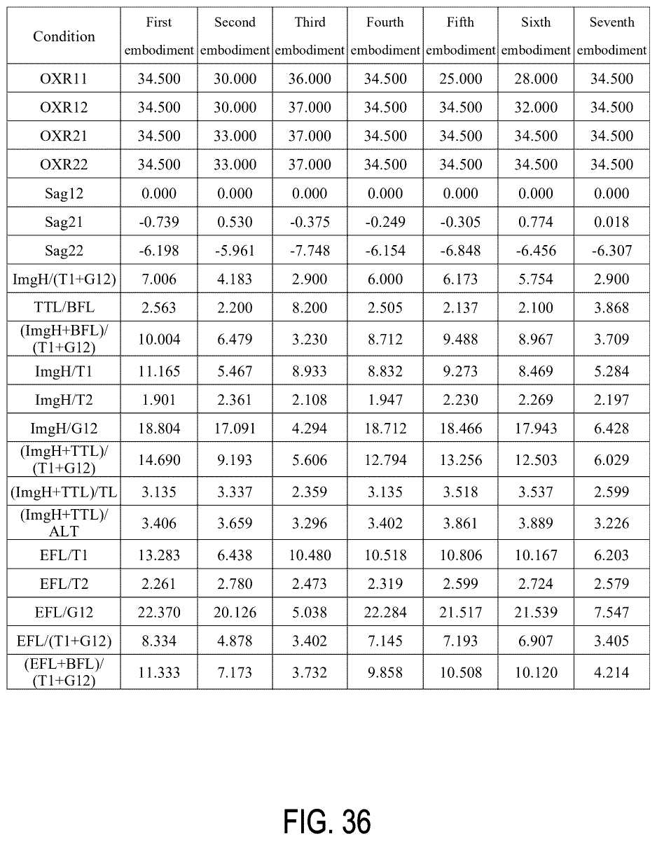

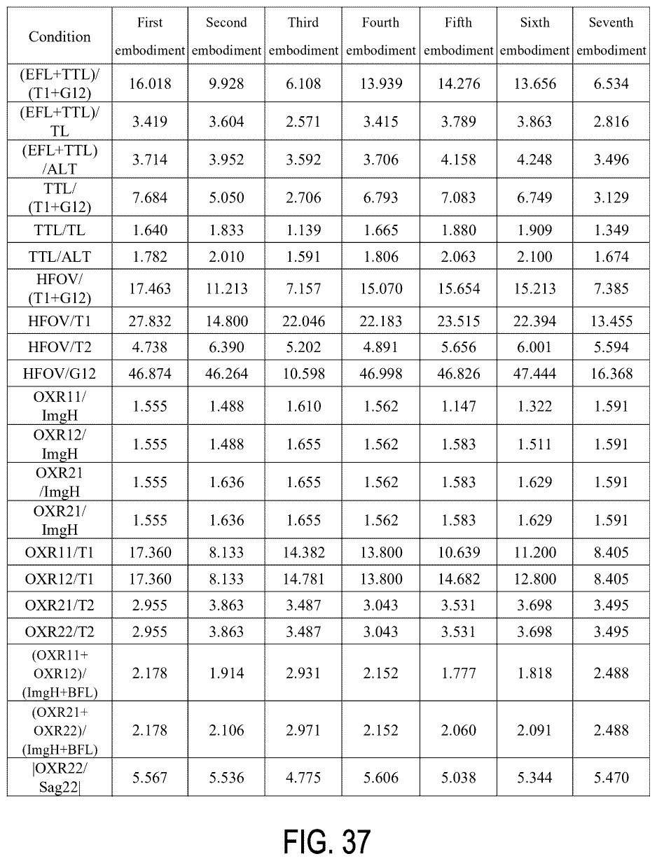

In another aspect, FIG. 35 to FIG. 37 demonstrate numerical values of relational expressions for various important parameters of the ocular optical systems in the first to seventh embodiments of the disclosure. Relations between various important parameters in the ocular optical system 10 of the first embodiment are shown in FIG. 35 to FIG. 37.

Where:
EFL is an effective focal length of the ocular optical system 10.
HFOV is a half field of view, which is a maximum angle of the half field of view of the observer.
ImgH is a maximum image height of the ocular optical system 10, which is half of an image circle diameter (ICD).
Fno is an F-number of the ocular optical system 10.
ObjH is a maximum height of the virtual image produced by the ocular optical system 10.
ObjD is a distance from the pupil 0 of the observer to the virtual image produced by the ocular optical system 10 on the optical axis I.
SL is a system length of the ocular optical system 10, which is a distance from the pupil 0 of the observer to the display screen 99 on the optical axis I.
TTL is a distance from the eye-side surface 15 of the first lens element 1 to the display screen 99 on the optical axis I.
ALT is a sum of thicknesses of the first lens element 1 and the second lens element 2 on the optical axis I, which is a sum of T1 and T2.
TL is a distance from the eye-side surface 15 of the first lens element 1 to the display-side surface 26 of the second lens element 2 on the optical axis I.
ER (Eye relief) is an exit pupil distance, which is a distance from the pupil 0 of the observer to the first lens element 1 on the optical axis I.
Tlp+Trp+Tqwp is a sum of thicknesses of the linear polarization film plus the reflective polarization film 3 and the quarter wave plate 4 on the optical axis I.
T1 is a thickness of the first lens element 1 on the optical axis I.
G12 is a distance from the display-side surface 16 of the first lens element 1 to the eye-side surface 25 of the second lens element 2 on the optical axis I.
T2 is a thickness of the second lens element 2 on the optical axis I.
BFL is a distance from the display-side surface 26 of the second lens element 2 to the display screen 99 on the optical axis I.
V1 is a Vd Abbe number of the first lens element 1.
V2 is a Vd Abbe number of the second lens element 2.
n1 is a nd refractive index of the first lens element 1.
n2 is a nd refractive index of the second lens element 2.
AAG is a distance from the display-side surface 15 of the first lens element 1 to the eye-side surface 26 of the second lens element 2 on the optical axis I, which is G12.
OXR11 is an optical maximum radius of the eye-side surface 15 of the first lens element 1.
OXR12 is an optical maximum radius of the display-side surface 16 of the first lens element 1.
OXR21 is an optical maximum radius of the eye-side surface 25 of the second lens element 2.
OXR22 is an optical maximum radius of the display-side surface 26 of the second lens element 2.
Sag12 is a Sag value of the display-side surface 16 of the first lens element 1 on the optical maximum radius, where Sag is a depth of the aspheric surface calculated by using the aspheric formula (the vertical distance between the point whose distance to the optical axis I is Y on the aspheric surface and the tangent plane tangent to the apex of the aspheric surface in the optical axis I).
Sag21 is a Sag value of the eye-side surface 25 of the second lens element 2 on the optical maximum radius.
Sag22 is a Sag value of the display-side surface 26 of the second lens element 2 on the optical maximum radius.

Additionally, the following is further defined:
EPD (Exit pupil diameter) is an exit pupil diameter of the ocular optical system 10, corresponding to a diameter of the pupil 0 of the observer, and equal to EFL/Fno.
f1 is a focal length of the first lens element 1.
f2 is a focal length of the second lens element 2.

It should be noted that f1, f2, f3 and EFL are the values calculated for the material at a wavelength of 546 nm; n1, n2, n3, V1, V2 and V3 are Vd and nd values of disclosure materials in accordance with the format of the International Glass Code.

Referring to FIG. 8A to FIG. 8D next, the diagram in FIG. 8A illustrates a longitudinal spherical aberration on the display screen 99 of the first embodiment when a representative wavelength is 546 nm. FIG. 8B and FIG. 8C respectively illustrate field curvature aberrations in a sagittal direction and field curvature aberrations in a tangential direction on the display screen 99 of the first embodiment when the wavelength is 546 nm. FIG. 8D illustrates a distortion aberration on the display screen 99 of the first embodiment when the wavelength is 546 nm. As shown in FIG. 8A, the longitudinal spherical aberration of the first embodiment demonstrates that the curves formed by the aforementioned wavelengths are close to each other and near the center, indicating that off-axis rays at different heights are concentrated near the imaging point. From deflection margin of the curves of the wavelengths, it may be observed that the imaging point deviation of the off-axis rays at different heights is controlled within a range of ±0.120 mm. Therefore, in the first embodiment, the spherical aberration of the same wavelength is indeed significantly improved.

In the two diagrams of the field curvature aberrations of FIG. 8B and FIG. 8C, the focal length variation of the representative wavelengths in the entire field of view range falls within a range of ±0.200 mm, indicating that the optical system of the first embodiment may effectively eliminate aberration. In FIG. 8D, the diagram of the distortion aberration shows that the distortion aberration of this embodiment is maintained within a range of ±50%, indicating that the distortion aberration of the first embodiment meets the imaging quality requirements of the optical system, and as a result, in comparison to the existing ocular optical systems, in the first embodiment, under the condition that the TTL is reduced to 24.338 mm, good imaging quality may still be provided. Therefore, in the first embodiment, under the condition of maintain good optical performance, a larger half field of view, smaller volume, and excellent imaging quality may be achieved.

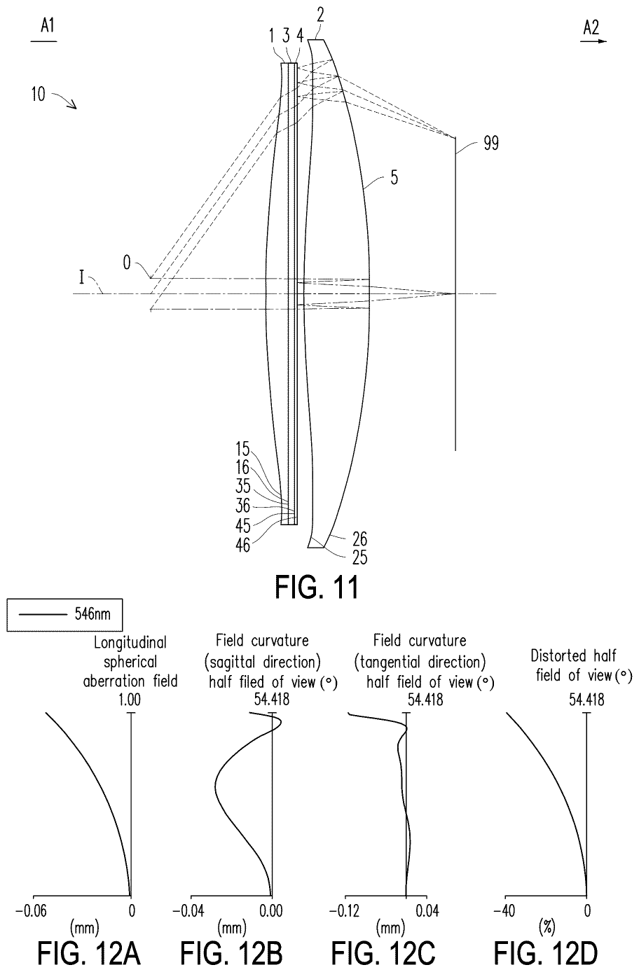

FIG. 11 is a schematic diagram of an ocular optical system according to the second embodiment of the disclosure. FIG. 12A to FIG. 12D are diagrams of longitudinal spherical aberrations and various aberrations of the ocular optical system according to the second embodiment. Referring to FIG. 11 first, the second embodiment of the ocular optical system 10 of the disclosure is generally similar to the first embodiment, and the difference between the two lies in that the optical data, the aspheric coefficients, and the parameters between the first lens element 1 and the second lens element 2 are slightly different. It should be mentioned here that, to clearly show the drawing, reference numerals of some of the optical axis regions and the periphery regions with the same surface shape as the first embodiment are omitted in FIG. 11.

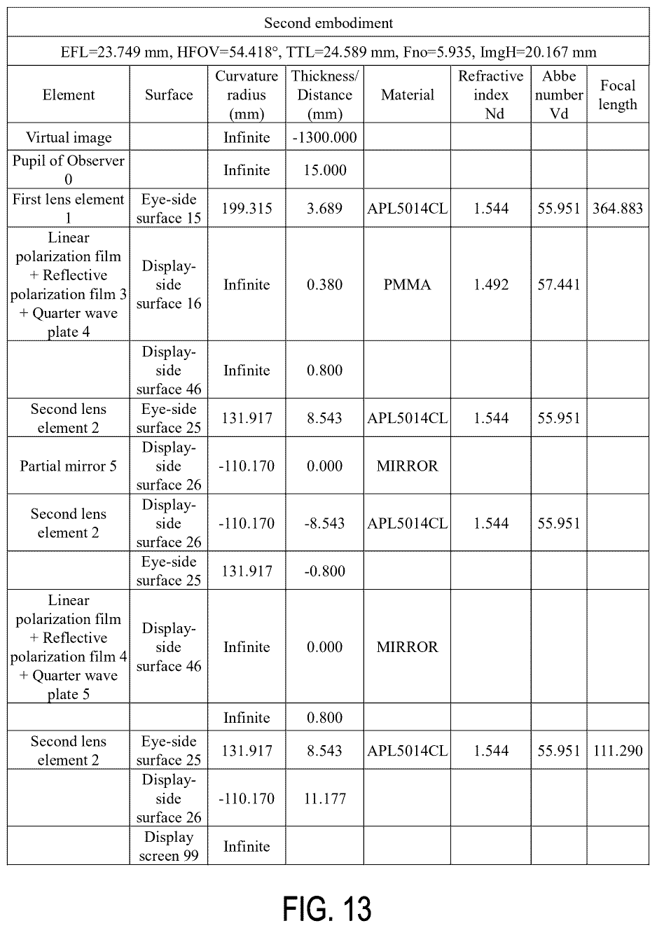

The detailed optical data of the ocular optical system 10 of the second embodiment is shown in FIG. 13. An EFL of the ocular optical system 10 of the second embodiment is 23.749 mm, an HFOV is 54.418 degrees, a TTL is 24.589 mm, an Fno is 5.935, and an ImgH is 20.167 mm.

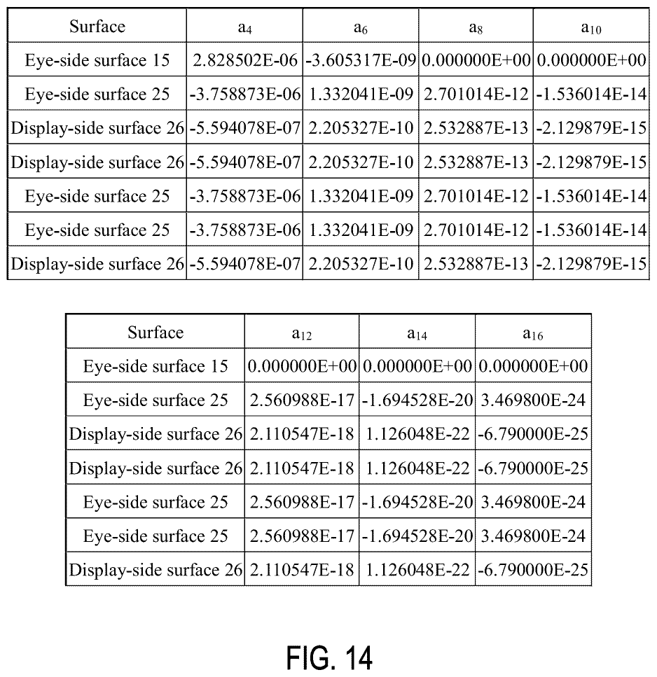

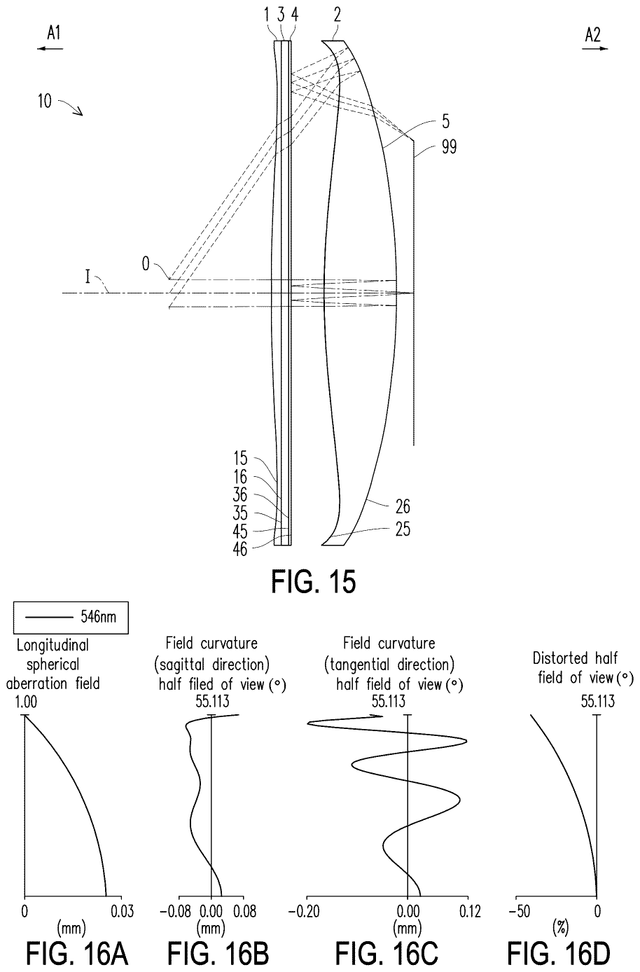

FIG. 14 also shows each aspheric coefficient of the eye-side surfaces 15, 25, 35, and 45, and the display-side surfaces 16, 26, 36, and 46 in the aforementioned formula (1) of the second embodiment.

In addition, the relations between various important parameters in the ocular optical system 10 of the second embodiment are shown in FIG. 35 to FIG. 37.

FIG. 12A demonstrates the longitudinal spherical aberration of the second embodiment, where the imaging point deviation of the off-axis rays at different heights is controlled within a range of ±0.060 mm. In the two diagrams of the field curvature aberrations of FIG. 12B and FIG. 12C, the focal length variation of the representative wavelengths in the entire field of view range falls within a range of ±0.120 mm. In FIG. 12D, the diagram of the distortion aberration shows that the distortion aberration of this embodiment is maintained within a range of ±40%.

It may be known from the above that the aperture of the second embodiment is larger than the aperture of the first embodiment. Therefore, compared with the first embodiment, the second embodiment has a larger light influx. Furthermore, the longitudinal spherical aberration of the second embodiment is smaller than the longitudinal spherical aberration of the first embodiment, the field curvature aberration of the second embodiment is smaller than the field curvature aberration of the first embodiment, and the distortion aberration of the second embodiment is smaller than the distortion aberration of the first embodiment, having better image quality.

FIG. 15 is a schematic diagram of an ocular optical system according to the third embodiment of the disclosure. FIG. 16A to FIG. 16D are diagrams of longitudinal spherical aberrations and various aberrations of the ocular optical system according to the third embodiment. Referring to FIG. 15 first, the third embodiment of the ocular optical system 10 of the disclosure is generally similar to the first embodiment, and the difference between the two lies in that the optical data, the aspheric coefficients, and the parameters between the first lens element 1, the second lens element 2, the linear polarization film plus the reflective polarization film 3, and the quarter wave plate 4 are slightly different. It should be mentioned here that, to clearly show the drawing, reference numerals of some of the optical axis regions and the periphery regions with the same surface shape as the first embodiment are omitted in FIG. 15.

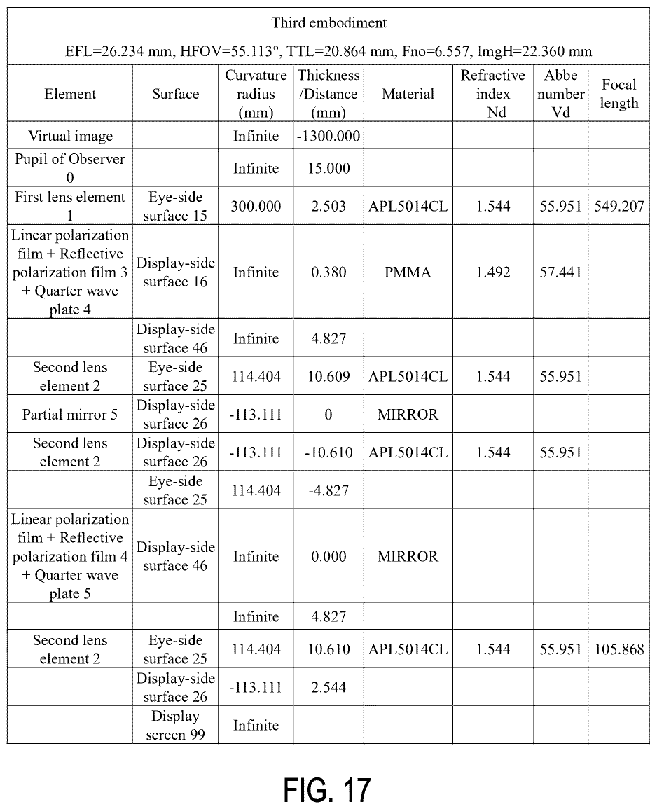

The detailed optical data of the ocular optical system 10 of the third embodiment is shown in FIG. 17. An EFL of the ocular optical system 10 of the third embodiment is 26.234 mm, an HFOV is 55.113 degrees, a TTL is 20.864 mm, an Fno is 6.557, and an ImgH is 22.360 mm.

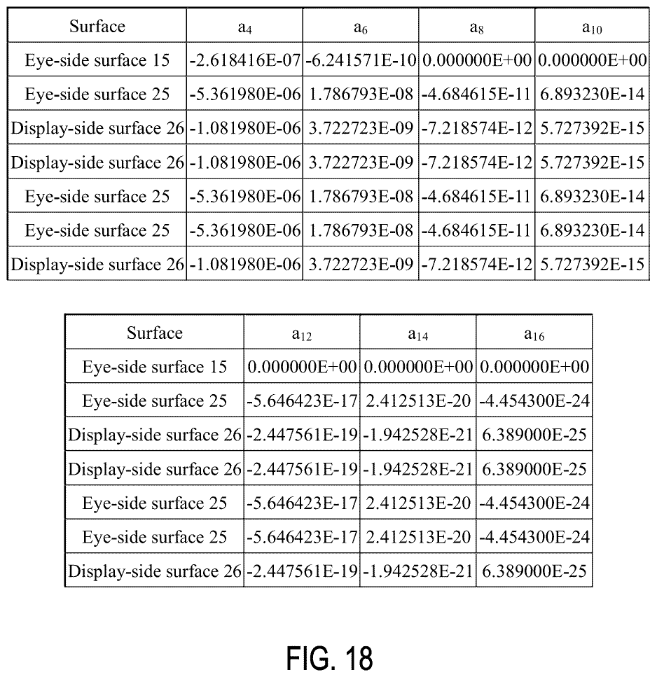

FIG. 18 also shows each aspheric coefficient of the eye-side surfaces 15, 25, 35, and 45, and the display-side surfaces 16, 26, 36, and 46 in the aforementioned formula (1) of the third embodiment.

In addition, the relations between various important parameters in the ocular optical system 10 of the third embodiment are shown in FIG. 35 to FIG. 37.

FIG. 16A demonstrates the longitudinal spherical aberration of the third embodiment, where the imaging point deviation of the off-axis rays at different heights is controlled within a range of ±0.030 mm. In the two diagrams of the field curvature aberrations of FIG. 16B and FIG. 16C, the focal length variation of the representative wavelengths in the entire field of view range falls within a range of ±0.200 mm. In FIG. 16D, the diagram of the distortion aberration shows that the distortion aberration of this embodiment is maintained within a range of ±50%.

It may be known from the above that the system length of the third embodiment is shorter than the system length of the first embodiment. Therefore, compared with the first embodiment, the third embodiment has a smaller volume. The aperture of the third embodiment is larger than aperture of the first embodiment. Therefore, compared with the first embodiment, the third embodiment has a larger light influx. The image height of the third embodiment is greater than the image height of the first embodiment. Therefore, compared with the first embodiment, the third embodiment has better photosensitivity. Furthermore, the longitudinal spherical aberration of the third embodiment is smaller than the longitudinal spherical aberration of the first embodiment, having better image quality.

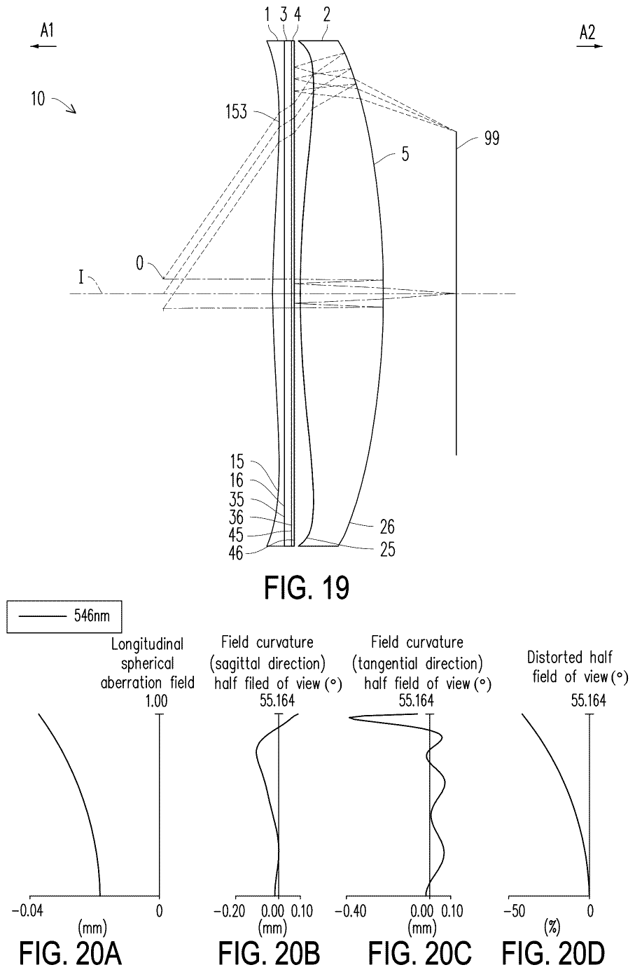

FIG. 19 is a schematic diagram of an ocular optical system according to the fourth embodiment of the disclosure. FIG. 20A to FIG. 20D are diagrams of longitudinal spherical aberrations and various aberrations of the ocular optical system according to the fourth embodiment. Referring to FIG. 19 first, the fourth embodiment of the ocular optical system 10 of the disclosure is generally similar to the first embodiment, and the difference between the two lies in that the optical data, the aspheric coefficients, and the parameters between the first lens element 1, the second lens element 2, the linear polarization film plus the reflective polarization film 3, and the quarter wave plate 4 are slightly different. Furthermore, in this embodiment, the periphery region 153 of the eye-side surface 15 of the first lens element 1 is a concave surface. It should be mentioned here that, to clearly show the drawing, reference numerals of some of the optical axis regions and the periphery regions with the same surface shape as the first embodiment are omitted in FIG. 19.

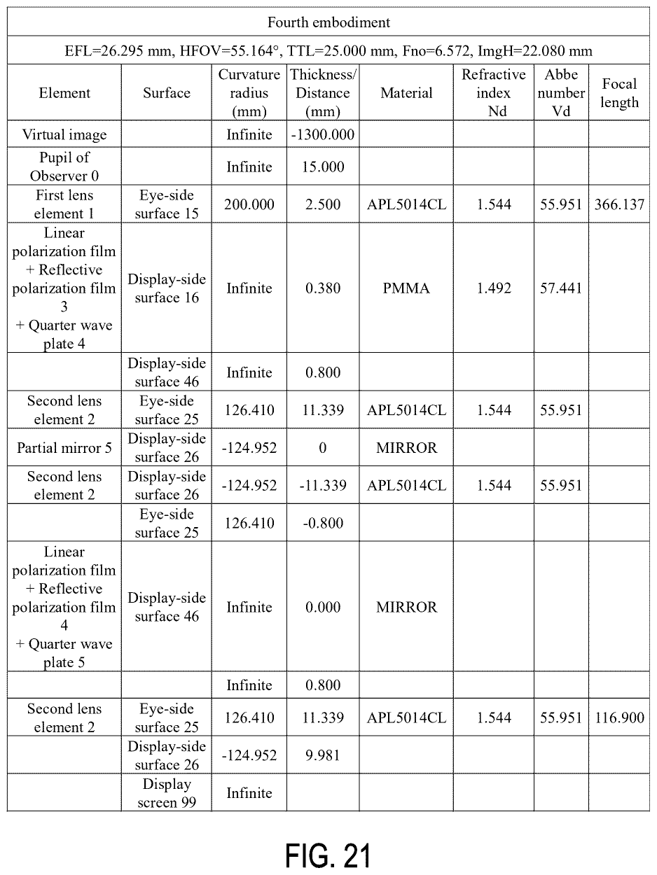

The detailed optical data of the ocular optical system 10 of the fourth embodiment is shown in FIG. 21. An EFL of the ocular optical system 10 of the fourth embodiment is 26.295 mm, an HFOV is 55.164 degrees, a TTL is 25.000 mm, an Fno is 6.572, and an ImgH is 22.080 mm.

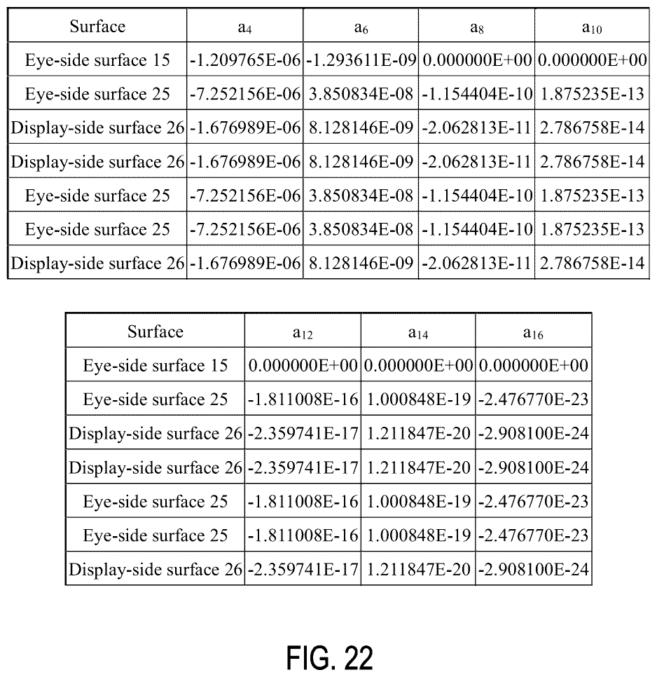

FIG. 22 also shows each aspheric coefficient of the eye-side surfaces 15, 25, 35, and 45, and the display-side surfaces 16, 26, 36, and 46 in the aforementioned formula (1) of the fourth embodiment.

In addition, the relations between various important parameters in the ocular optical system 10 of the fourth embodiment are shown in FIG. 35 to FIG. 37.

FIG. 20A demonstrates the longitudinal spherical aberration of the fourth embodiment, where the image point deviation of the off-axis rays at different heights is controlled within a range of ±0.040 mm. In the two diagrams of the field curvature aberrations of FIG. 20B and FIG. 20C, the focal length variation of the representative wavelengths in the entire field of view falls within a range of ±0.400 mm. In FIG. 20D, the diagram of the distortion aberration shows that the distortion aberration of this embodiment is maintained within a range of ±50%.

It may be known from the above that the half field of view of the fourth embodiment is greater than the half field of view of the first embodiment. Therefore, compared with the first embodiment, the fourth embodiment has a larger angular range for receiving images. The aperture of the fourth embodiment is larger than the aperture of the first embodiment. Therefore, compared with the first embodiment, the fourth embodiment has a larger light influx. The image height of the fourth embodiment is greater than the image height of the first embodiment. Therefore, compared with the first embodiment, the fourth embodiment has better photosensitivity. Furthermore, the longitudinal spherical aberration of the fourth embodiment is smaller than the longitudinal spherical aberration of the first embodiment, having better image quality.

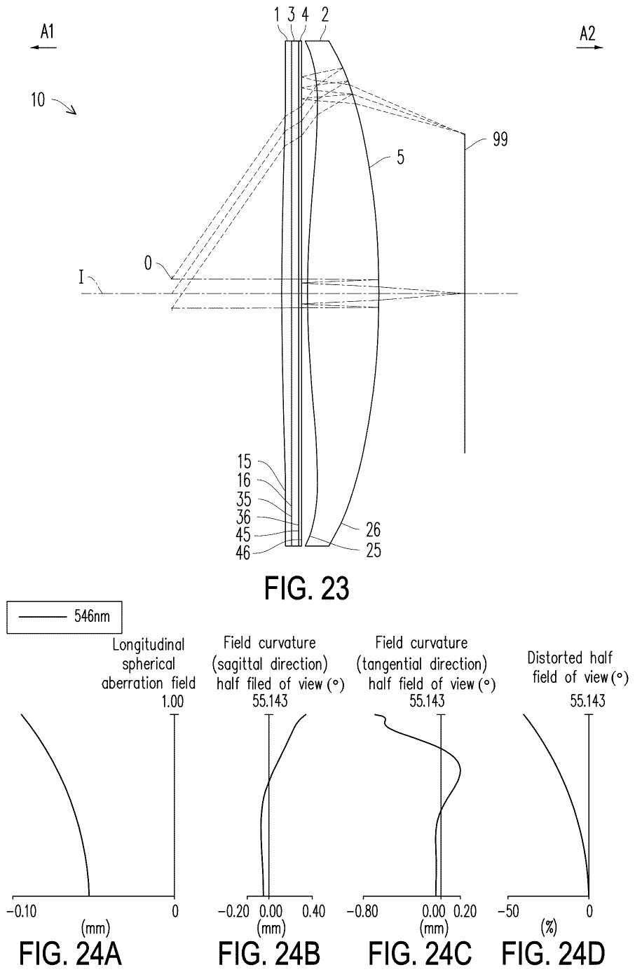

FIG. 23 is a schematic diagram of an ocular optical system according to the fifth embodiment of the disclosure. FIG. 24A to FIG. 24D are diagrams of longitudinal spherical aberrations and various aberrations of the ocular optical system according to the fifth embodiment. Referring to FIG. 23 first, the fifth embodiment of the ocular optical system 10 of the disclosure is generally similar to the first embodiment, and the difference between the two lies in that the optical data, the aspheric coefficients, and the parameters between the first lens element 1, the second lens element 2, the linear polarization film plus the reflective polarization film 3, and the quarter wave plate 4 are slightly different. It should be mentioned here that, to clearly show the drawing, reference numerals of some of the optical axis regions and the periphery regions with the same surface shape as the first embodiment are omitted in FIG. 23.

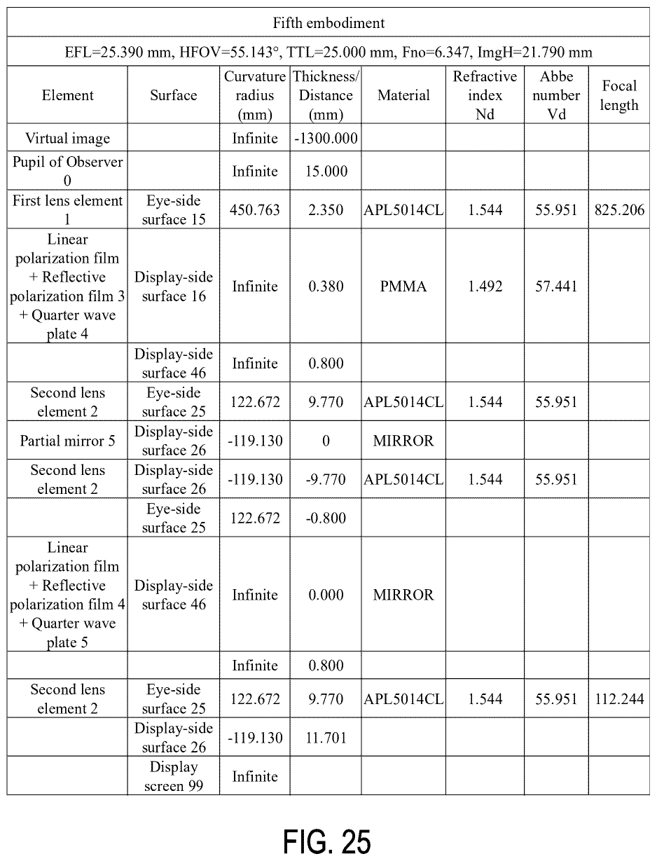

The detailed optical data of the ocular optical system 10 of the fifth embodiment is shown in FIG. 25. An EFL of the ocular optical system 10 of the fifth embodiment is 25.390 mm, an HFOV is 55.143 degrees, a TTL is 25.000 mm, an Fno is 6.347, and an ImgH is 21.790 mm.

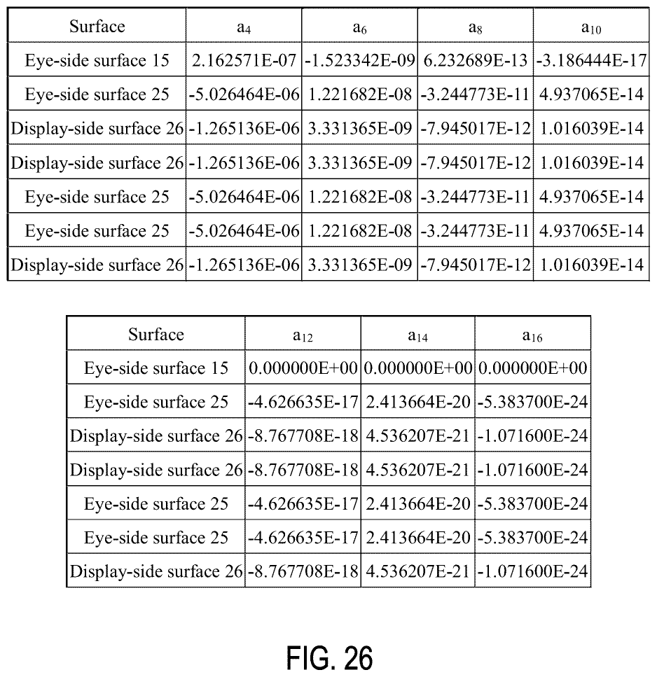

FIG. 26 also shows each aspheric coefficient of the eye-side surfaces 15, 25, 35, and 45, and the display-side surfaces 16, 26, 36, and 46 in the aforementioned formula (1) of the fifth embodiment.

In addition, the relations between various important parameters in the ocular optical system 10 of the fifth embodiment are shown in FIG. 35 to FIG. 37.

FIG. 24A demonstrates the longitudinal spherical aberration of the fifth embodiment, where the imaging point deviation of the off-axis rays at different heights is controlled within a range of ±0.10 mm. In the two diagrams of the field curvature aberrations of FIG. 24B and FIG. 24C, the focal length variation of the representative wavelengths in the entire field of view falls within a range of ±0.800 mm. In FIG. 24D, the diagram of the distortion aberration shows that the distortion aberration of this embodiment is maintained within a range of ±50%.

It may be known from the above that the aperture of the fifth embodiment is larger than the aperture of the first embodiment. Therefore, compared with the first embodiment, the fifth embodiment has a larger light influx. The image height of the fifth embodiment is greater than the image height of the first embodiment. Therefore, compared with the first embodiment, the fifth embodiment has better photosensitivity. Furthermore, the longitudinal spherical aberration of the fifth embodiment is smaller than the longitudinal spherical aberration of the first embodiment, having better image quality.

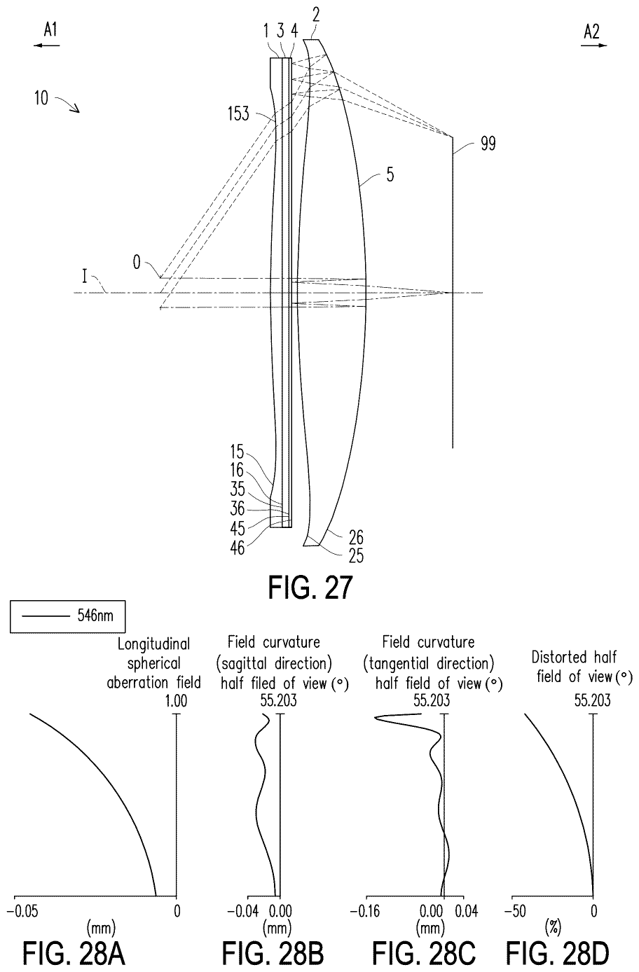

FIG. 27 is a schematic diagram of an ocular optical system according to the sixth embodiment of the disclosure. FIG. 28A to FIG. 28D are diagrams of longitudinal spherical aberrations and various aberrations of the ocular optical system according to the sixth embodiment. Referring to FIG. 27 first, the sixth embodiment of the ocular optical system 10 of the disclosure is generally similar to the first embodiment, and the difference between the two lies in that the optical data, the aspheric coefficients, and the parameters between the first lens element 1, the second lens element 2, the linear polarization film plus the reflective polarization film 3, and the quarter wave plate 4 are slightly different. Furthermore, in this embodiment, the periphery region 153 of the eye-side surface 15 of the first lens element 1 is a concave surface. It should be mentioned here that, to clearly show the drawing, reference numerals of some of the optical axis regions and the periphery regions with the same surface shape as the first embodiment are omitted in FIG. 27.

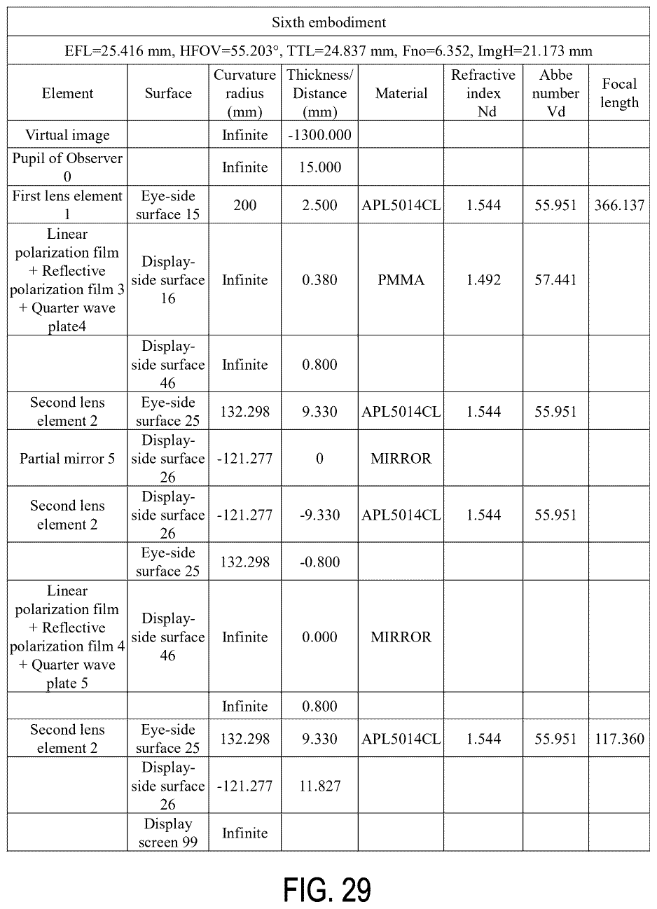

The detailed optical data of the ocular optical system 10 of the sixth embodiment are shown in FIG. 29. An EFL the ocular optical system 10 of the sixth embodiment is 25.416 mm, an HFOV is 55.203 degrees, a TTL is 24.837 mm, an Fno is 6.352, and an ImgH is 21.173 mm.

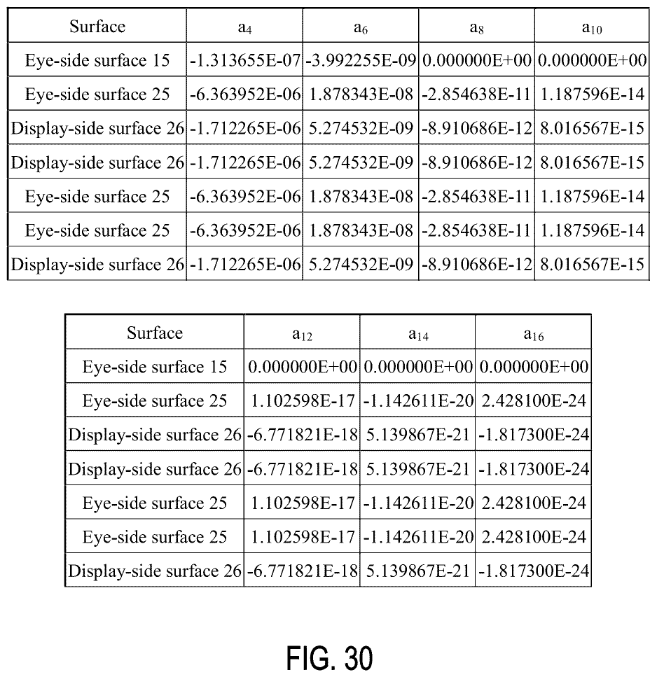

FIG. 30 also shows each aspheric coefficient of the eye-side surfaces 15, 25, 35, and 45, and the display-side surfaces 16, 26, 36, and 46 in the aforementioned formula (1) of the sixth embodiment.

In addition, the relations between various important parameters in the ocular optical system 10 of the sixth embodiment are shown in FIG. 35 to FIG. 37.

FIG. 28A demonstrates the longitudinal spherical aberration of the sixth embodiment, where the imaging point deviation of the off-axis rays at different heights is controlled within a range of ±0.050 mm. In the two diagrams of the field curvature aberrations of FIG. 28B and FIG. 28C, the focal length variation of the representative wavelengths in the entire field of view falls within a range of ±0.16 mm. In FIG. 28D, the diagram of the distortion aberration shows that the distortion aberration of this embodiment is maintained within a range of ±50%.

It may be known from the above that the half field of view of the sixth embodiment is greater than the half field of view of the first embodiment. Therefore, compared with the first embodiment, the sixth embodiment has a larger angular range for receiving images. The aperture of the sixth embodiment is larger than the aperture of the first embodiment. Therefore, compared with the first embodiment, the sixth embodiment has a larger light influx. Furthermore, the longitudinal spherical aberration of the sixth embodiment is smaller than the longitudinal spherical aberration of the first embodiment, having better image quality.

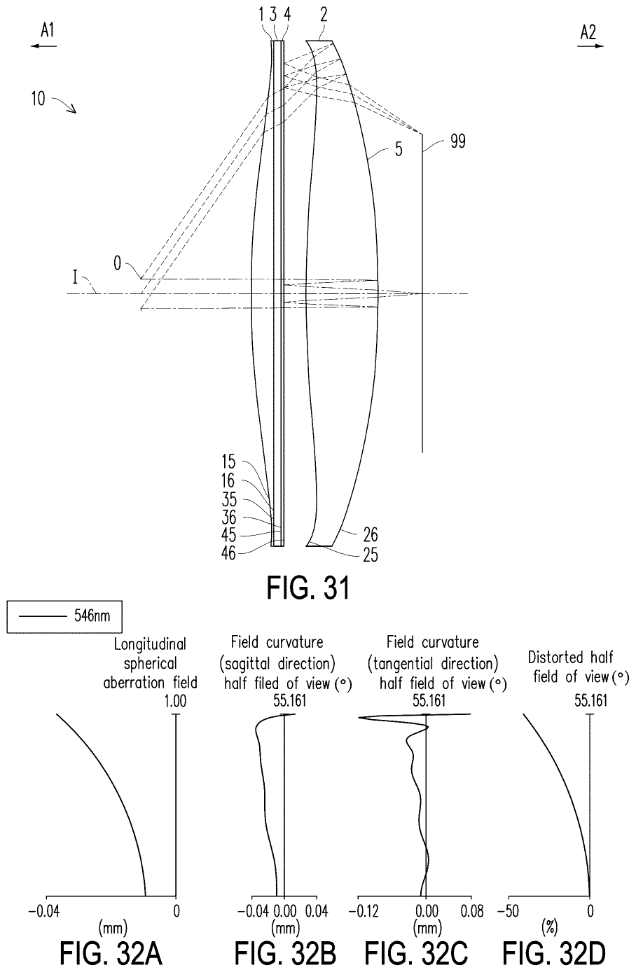

FIG. 31 is a schematic diagram of an ocular optical system according to the seventh embodiment of the disclosure. FIG. 32A to FIG. 32D are diagrams of longitudinal spherical aberrations and various aberrations of the ocular optical system according to the seventh embodiment. Referring to FIG. 31 first, the seventh embodiment of the ocular optical system 10 of the disclosure is generally similar to the first embodiment, and the difference between the two lies in that the optical data, the aspheric coefficients, and the parameters between the first lens element 1, the second lens element 2, the linear polarization film plus the reflective polarization film 3, and the quarter wave plate 4 are slightly different. It should be mentioned here that, to clearly show the drawing, reference numerals of some of the optical axis regions and the periphery regions with the same surface shape as the first embodiment are omitted in FIG. 31.

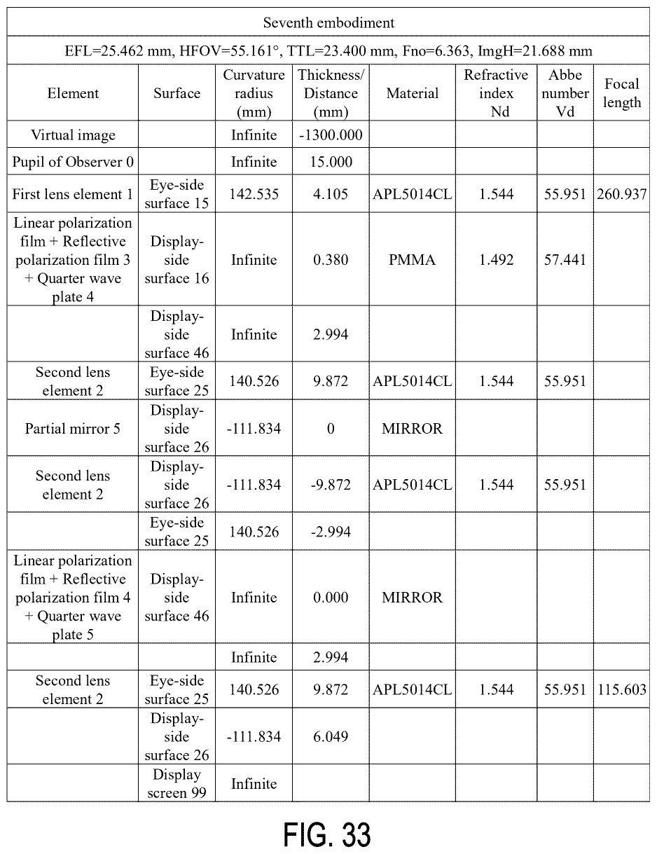

The detailed optical data of the ocular optical system 10 of the seventh embodiment are shown in FIG. 33. An EFL ocular optical system 10 of the seventh embodiment is 25.462 mm, an HFOV is 55.161 degrees, a TTL is 23.400 mm, an Fno is 6.363, and an ImgH is 21.688 mm.

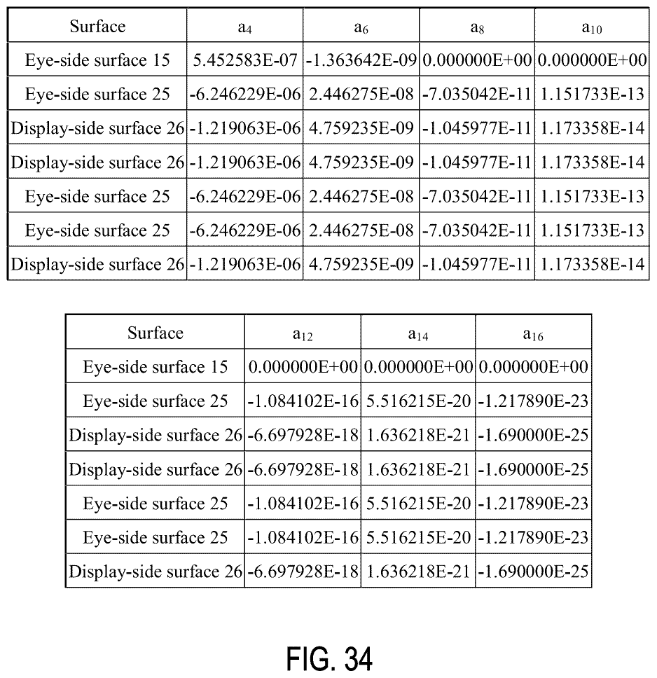

FIG. 34 also shows each aspheric coefficient of the eye-side surfaces 15, 25, 35, and 45, and the display-side surfaces 16, 26, 36, and 46 in the aforementioned formula (1) of the seventh embodiment.

In addition, the relations between various important parameters in the ocular optical system 10 of the seventh embodiment are shown in FIG. 35 to FIG. 37.

FIG. 32A demonstrates the longitudinal spherical aberration of the seventh embodiment, where the imaging point deviation of the off-axis rays at different heights is controlled within a range of ±0.040 mm. In the two diagrams of the field curvature aberrations of FIG. 32B and FIG. 32C, the focal length variation of the representative wavelengths in the entire field of view falls within a range of ±0.120 mm. In FIG. 32D, the diagram of the distortion aberration shows that the distortion aberration of this embodiment is maintained within a range of ±50%.

It may be known from the above that the system length of the seventh embodiment is shorter than the system length of the first embodiment. Therefore, compared to the first embodiment, the seventh embodiment has a smaller volume. The aperture of the seventh embodiment is larger than the aperture of the first embodiment. Therefore, compared with the first embodiment, the seventh embodiment has a larger light influx. The image height of the seventh embodiment is greater than the image height of the first embodiment. Therefore, compared with the first embodiment, the seventh embodiment has better photosensitivity. Furthermore, the longitudinal spherical aberration of the seventh embodiment is smaller than the longitudinal spherical aberration of the first embodiment, and the field curvature aberration of the seventh embodiment is smaller than the field curvature aberration of the first embodiment, having better image quality.

In an embodiment of the disclosure, when the linear polarization film plus the reflective polarization film 3 and the quarter wave plate 4 are disposed on the plane of the display-side surface 16 of the first lens element 1, it is beneficial to reduce a film attachment process to decrease manufacturing costs. Moreover, when the optical axis region 251 of the eye-side surface 25 of the second lens element 2 is a convex surface, it may effectively converge an incident ray. In coordination with TTL/BFL≤8.200, it is beneficial to reduce the system length and increasing the half field of view. A more beneficial limit is 2.100≤TTL/BFL≤8.200. In coordination with ImgH/(T1+G12)≥2.900, it is beneficial to reduce the size of the display by controlling the thickness of the lens element, and decreasing the volume and weight of the display, thereby reducing the volume and weight of the ocular optical system 10. A more beneficial limit is 7.100≥ImgH/(T1+G12)≥2.900.

In an embodiment of the disclosure, when the linear polarization film plus the reflective polarization film 3 and quarter wave plate 4 are disposed on the plane of the display-side surface 16 of the first lens element 1, it is beneficial to reduce the film attachment process to decrease manufacturing costs. Moreover, when the optical axis region 251 of the eye-side surface 25 of the second lens element 2 is a convex surface, it may effectively converge the incident ray. In coordination with TTL/BFL≤8.200, it is beneficial for reducing the system length and increasing the half field of view. A more beneficial limit is 2.100≤TTL/BFL≤8.200. In coordination with (ImgH+BFL)/(T1+G12)≥3.200, it is beneficial to decrease the volume and weight of the display, thereby reducing the volume and weight of the ocular optical system 10. It is beneficial to maintain the image height while the optimal distance of the optical back focal length is maintained. A more beneficial limit is 10.100≥(ImgH+BFL)/(T1+G12)≥3.200.

In an embodiment of the disclosure, when the linear polarization film plus the reflective polarization film 3 and the quarter wave plate 4 are disposed on the plane of the display-side surface 16 of the first lens element 1, it is beneficial to reduce the film attachment process to decrease manufacturing costs. Moreover, when the optical axis region 251 of the eye-side surface 25 of the second lens element 2 is a convex surface, it may effectively converge incident rays. In the aforementioned configuration, along with the condition that the periphery region 253 of the eye-side surface 25 of the second lens element 2 is a concave surface, it is beneficial to increase the half field of view through the principles of reflection and polarization. In coordination with (ImgH+BFL)/(T1+G12)≥3.500, it is beneficial to decrease the volume and weight of the display, thereby reducing the volume and weight of the ocular optical system 10. It is beneficial to maintain the image height while the optimal distance of the optical back focal length is maintained. A more beneficial limit is 10.100≥(ImgH+BFL)/(T1+G12)≥3.700.

In an embodiment of the disclosure, when the linear polarization film plus the reflective polarization film 3 and the quarter wave plate 4 are disposed on the plane of the display-side surface 16 of the first lens element 1, it is beneficial to reduce the film attachment process to decrease manufacturing costs. Moreover, when the optical axis region 251 of the eye-side surface 25 of the second lens element 2 is a convex surface, it may effectively converge incident rays. In the aforementioned configuration, along with the partial reflective mirror 5 disposed on the convex surface of the display-side surface 26 of the second lens element 2, it is beneficial to increase the half field of view through the principles of reflection and polarization.

Further, the ocular optical system 10 may satisfy the following conditions: 4.800≤ImgH/T1; or 1.700≤ImgH/T2; or 3.900≤ImgH/G12; or 5.000≤(ImgH+TTL)/(T1+G12); or 2.100≤(ImgH+TTL)/TL; or 2.900≤(ImgH+TTL)/ALT. As these conditions are matched, it is beneficial to reduce the volume and weight of the display (that is, the display that shows the display screen 99), thereby decreasing the volume and weight of the ocular optical system 10. A preferable range is: 5.200≤ImgH/T1≤11.200; or 1.900≤ImgH/T2≤2.400; or 4.200≤ImgH/G12≤18.900; or 5.600≤(ImgH+TTL)/(T1+G12)≤14.700; or 2.300≤(ImgH+TTL)/TL≤3.600; or 3.200≤(ImgH+TTL)/ALT≤3.900.

Further, the ocular optical system 10 may satisfy the following conditions: 5.500≤EFL/T1; or EFL/T2≤3.000; or EFL/G12≤24.600; or 3.000≤EFL/(T1+G12); or 3.400≤(EFL+BFL)/(T1+G12); or 5.500≤(EFL+TTL)/(T1+G12); or 2.300≤(EFL+TTL)/TL; or 3.100≤(EFL+TTL)/ALT; or 2.400≤TTL/(T1+G12); or TTL/TL≤2.100; or TTL/ALT≤2.300. Matching these conditions is favorable to shortening the system length, thereby decreasing the volume and weight of the ocular optical system 10. A preferable range is: 6.200≤EFL/T1≤13.300; or 2.200≤EFL/T2≤2.800; or 5.000≤EFL/G12≤22.400; or 3.400≤EFL/(T1+G12)≤8.400; or 3.700≤(EFL+BFL)/(T1+G12)≤11.400; or 6.100≤(EFL+TTL)/(T1+G12)≤16.100; or 2.500≤(EFL+TTL)/TL≤3.900; or 3.400≤(EFL+TTL)/ALT≤4.300; or 2.700≤TTL/(T1+G12)≤7.700; or 1.100≤TTL/TL≤2.000; or 1.500≤TTL/ALT≤2.100.

Further, the ocular optical system 10 may satisfy the following conditions: 6.400 degrees/mm≤HFOV/(T1+G12); or 12.100 degrees/mm≤HFOV/T1; or 4.300 degrees/mm≤HFOV/T2; or 9.500 degrees/mm≤HFOV/G12. As these conditions are matched, it is beneficial to reduce the system length while a good half field of view is maintained, thereby decreasing the volume and weight of the ocular optical system 10. A preferable range is: 7.100 degrees/mm≤HFOV/(T1+G12)≤17.500 degrees/mm; or 13.400 degrees/mm≤HFOV/T1≤27.900 degrees/mm; or 4.700 degrees/mm HFOV/T2≤6.400 degrees/mm; or 10.500 degrees/mm≤HFOV/G12≤47.500 degrees/mm.

Further, the ocular optical system 10 may satisfy the following conditions: 1.000≤OXR11/ImgH≤1.800; or 1.300≤OXR12/ImgH≤1.800; or 1.400≤OXR21/ImgH≤1.800; or 1.400 OXR22/ImgH≤1.800. As these conditions are matched, it is beneficial to decrease the volume and weight of the display (that is, the display that shows the display screen 99), thereby decreasing the volume and weight of the ocular optical system 10.

Further, the ocular optical system 10 may satisfy the following conditions: 7.3005≤OXR11/T1≤19.100; or 7.300≤OXR12/T1≤19.100; or 2.700≤OXR21/T2≤4.200; or 2.700≤OXR22/T2≤4.200. As these conditions are matched, it is beneficial to maintain the thickness and size of the first lens element 1 and the second lens element 2 within an appropriate range, thereby increasing the manufacturing yield.

Further, the ocular optical system 10 may satisfy the following condition: 1.600≤(OXR11+OXR12)/(ImgH+BFL)≤3.200; or 1.800≤(OXR21+OXR22)/(ImgH+BFL)≤3.300. As these conditions are matched, it is beneficial to increase the magnification of the virtual image formed by the display screen 99 with a premise of decreasing the volume and weight of the display.

Further, the ocular optical system 10 may satisfy the following condition: 4.300≤|OXR22/Sag22|≤6.200, which is beneficial to increase the manufacturing yield with the premise of decreasing the volume and weight of the display.

In summary, the beneficial effects of the ocular optical system according to the embodiments of the disclosure are as follows: by satisfying the conditions of optical design, and disposing the linear polarizing film, the reflective polarizing film, and the quarter wave plate all on the plane of the display-side surface of the first lens element, it is beneficial to reduce the film attachment process to decrease manufacturing costs, which contributes to the lightweight design of the ocular optical system. Moreover, when the optical axis region of the eye-side surface of the second lens element is a convex surface, the incident ray may effectively converge. Furthermore, disposing a partial reflective mirror on the display-side surface of the second lens element is also beneficial to increase the half field of view according to principles of reflection and polarization and satisfy a demand of the consumer for a wide field of view of the image.

The contents in the embodiments of the invention include but are not limited to a focal length, a thickness of a lens element, an Abbe number, or other optical parameters. For example, in the embodiments of the invention, an optical parameter A and an optical parameter B are disclosed, wherein the ranges of the optical parameters, comparative relation between the optical parameters, and the range of a conditional expression covered by a plurality of embodiments are specifically explained as follows:

(1) The ranges of the optical parameters are, for example, α≤A≤α or β≤B≤β, where α is a maximum value of the optical parameter A among the plurality of embodiments, α is a minimum value of the optical parameter A among the plurality of embodiments, β is a maximum value of the optical parameter B among the plurality of embodiments, and β is a minimum value of the optical parameter B among the plurality of embodiments.

(2) The comparative relation between the optical parameters is that A is greater than B or A is less than B, for example.

(3) The range of a conditional expression covered by a plurality of embodiments is in detail a combination relation or proportional relation obtained by a possible operation of a plurality of optical parameters in each same embodiment. The relation is defined as E, and E is, for example, A+B or A-B or A/B or A*B or (A*B), and E satisfies a conditional expression E≤γ or E≥γ or γ≤E≤γ, where each of γ and γ is a value obtained by an operation of the optical parameter A and the optical parameter B in a same embodiment, γ is a maximum value among the plurality of the embodiments, and γ is a minimum value among the plurality of the embodiments.

The ranges of the aforementioned optical parameters, the aforementioned comparative relations between the optical parameters, and a maximum value, a minimum value, and the numerical range between the maximum value and the minimum value of the aforementioned conditional expressions are all implementable and all belong to the scope disclosed by the invention. The aforementioned description is for exemplary explanation, but the invention is not limited thereto.

The embodiments of the invention are all implementable. In addition, a combination of partial features in a same embodiment can be selected, and the combination of partial features can achieve the unexpected result of the invention with respect to the prior art. The combination of partial features includes but is not limited to the surface shape of a lens element, a refracting power, a conditional expression or the like, or a combination thereof. The description of the embodiments is for explaining the specific embodiments of the principles of the invention, but the invention is not limited thereto. Specifically, the embodiments and the drawings are for exemplifying, but the invention is not limited thereto.

What is claimed is:

1. An ocular optical system, configured to allow an imaging ray from a display screen to enter an eye of an observer through the ocular optical system to form an image, wherein a side toward the eye is an eye side, a side toward the display screen is a display side, the ocular optical system sequentially comprises a first lens element and a second lens element along an optical axis from the eye side to the display side, the first lens element to the second lens element each comprises an eye-side surface facing the eye side and allowing the imaging ray to pass and a display-side surface facing the display side and allowing the imaging ray to pass, and the ocular optical system further comprises a linear polarization film, a reflective polarization film, a quarter wave plate, and a partial mirror;
the quarter wave plate being disposed on the reflective polarization film, the reflective polarization film being disposed on the linear polarization film, and the linear polarization film being disposed on a plane of an optical axis region of the display-side surface of the first lens element;
an optical axis region of the eye-side surface of the second lens element being a convex surface; and
the ocular optical system satisfying following conditional expressions: TTL/BFL≤8.200 and ImgH/(T1+G12)≥2.900, wherein TTL is a distance from the eye-side surface of the first lens element to the display screen on the optical axis, BFL is a distance from the display-side surface of the second lens element to the display screen on the optical axis, ImgH is a maximum image height of the ocular optical system, T1 is a thickness of the first lens element on the optical axis, and G12 is a distance from the display-side surface of the first lens element to the eye-side surface of the second lens element on the optical axis.

2. The ocular optical system according to claim 1, wherein the ocular optical system further satisfies a following conditional expression: ImgH/T1≥4.800.

3. The ocular optical system according to claim 1, wherein the ocular optical system further satisfies a following conditional expression: EFL/T1≥5.500, wherein EFL is a system focal length of the ocular optical system.

4. The ocular optical system according to claim 1, wherein the ocular optical system further satisfies a following conditional expression: 1.300≤OXR12/ImgH≤1.800, wherein OXR12 is a maximum optical radius of the display-side surface of the first lens element.

5. The ocular optical system according to claim 1, wherein the ocular optical system further satisfies a following conditional expression: ImgH/G12≥3.900.

6. The ocular optical system according to claim 1, wherein the ocular optical system further satisfies a following conditional expression: EFL/G12≤24.600, wherein EFL is a system focal length of the ocular optical system.

7. The ocular optical system according to claim 1, wherein the ocular optical system further satisfies a following conditional expression: 2.700≤OXR22/T2≤4.200, wherein OXR22 is a maximum optical radius of the display-side surface of the second lens element, and T2 is a thickness of the second lens element on the optical axis.

8. An ocular optical system, configured to allow an imaging ray from a display screen to enter an eye of an observer through the ocular optical system to form an image, wherein a side toward the eye is an eye side and a side toward the display screen is a display side, the ocular optical system sequentially comprises a first lens element and a second lens element along an optical axis from the eye side to the display side, the first lens element to the second lens element each comprises an eye-side surface facing the eye side and allowing the imaging ray to pass and a display-side surface facing the display side and allowing the imaging ray to pass, and the ocular optical system further comprises a linear polarization film, a reflective polarization film, a quarter wave plate, and a partial mirror;
the quarter wave plate being disposed on the reflective polarization film, the reflective polarization film being disposed on the linear polarization film, the linear polarization film being disposed on a plane of an optical axis region of the display-side surface of the first lens element;
an optical axis region of the eye-side surface of the second lens element being a convex surface; and
the ocular optical system satisfying following conditional expressions: 2.100≤TTL/BFL≤8.200 and (ImgH+BFL)/(T1+G12)≥3.200, wherein TTL is a distance from the eye-side surface of the first lens element to the display screen on the optical axis, BFL is a distance from the display-side surface of the second lens element to the display screen on the optical axis, ImgH is a maximum image height of the ocular optical system, T1 is a thickness of the first lens element on the optical axis, and G12 is a distance from the display-side surface of the first lens element to the eye-side surface of the second lens element on the optical axis.

9. The ocular optical system according to claim 8, wherein the ocular optical system further satisfies a following conditional expression: ImgH/T2≥1.700, wherein T2 is a thickness of the second lens element on the optical axis.

10. The ocular optical system according to claim 8, wherein the ocular optical system further satisfies a following conditional expression: EFL/T2≤3.000, wherein EFL is a system focal length of the ocular optical system, and T2 is a thickness of the second lens element on the optical axis.

11. The ocular optical system according to claim 8, wherein the ocular optical system further satisfies a following conditional expression: EFL/(T1+G12)≥3.000, wherein EFL is a system focal length of the ocular optical system.

12. The ocular optical system according to claim 8, wherein the ocular optical system further satisfies a following conditional expression: (EFL+BFL)/(T1+G12)≥3.400, wherein EFL is a system focal length of the ocular optical system.

13. The ocular optical system according to claim 8, wherein the ocular optical system further satisfies a following conditional expression: 1.600≤(OXR11+OXR12)/(ImgH+BFL)≤3.200, wherein OXR11 is a maximum optical radius of the eye-side surface of the first lens element, and OXR12 is a maximum optical radius of the display-side surface of the first lens element.

14. The ocular optical system according to claim 8, wherein the ocular optical system further satisfies a following conditional expression: 7.300≤OXR12/T1≤19.100, wherein OXR12 is a maximum optical radius of the display-side surface of the first lens element.

15. An ocular optical system, configured to allow an imaging ray from a display screen to enter an eye of an observer through the ocular optical system to form an image, wherein a side toward the eye is an eye side and a side toward the display screen is a display side, the ocular optical system sequentially comprises a first lens element and a second lens element along an optical axis from the eye side to the display side, the first lens element to the second lens element each comprises an eye-side surface facing the eye side and allowing the imaging ray to pass and a display-side surface facing the display side and allowing the imaging ray to pass, and the ocular optical system further comprises a linear polarization film, a reflective polarization film, a quarter wave plate, and a partial mirror;
the optical axis region of the display-side surface of the first lens element being a plane;
the optical axis region of the eye-side surface of the second lens element being a convex surface, and a peripheral region of the eye-side surface of the second lens element being a concave surface;
the ocular optical system satisfying a following conditional expression: (ImgH+BFL)/(T1+G12)≥3.500, wherein ImgH is a maximum image height of the ocular optical system, BFL is a distance from the display-side surface of the second lens element to the display screen on the optical axis, T1 is a thickness of the first lens element on the optical axis, and G12 is a distance from the display-side surface of the first lens element to the eye-side surface of the second lens element on the optical axis.

16. The ocular optical system according to claim 15, wherein the ocular optical system further satisfies a following conditional expression: (ImgH+TTL)/(T1+G12)≥5.000, wherein TTL is a distance from the eye-side surface of the first lens element to the display screen on the optical axis.

17. The ocular optical system according to claim 15, wherein the ocular optical system further satisfies a following conditional expression: (ImgH+TTL)/TL≥2.100, wherein TTL is a distance from the eye-side surface of the first lens element to the display screen on the optical axis, and TL is a distance from the eye-side surface of the first lens element to the display-side surface of the second lens element on the optical axis.

18. The ocular optical system according to claim 15, wherein the ocular optical system further satisfies a following conditional expression: (ImgH+TTL)/ALT≥2.900, wherein TTL is a distance from the eye-side surface of the first lens element to the display screen on the optical axis, and ALT is a sum of thicknesses of the first lens element and the second lens element on the optical axis.

19. The ocular optical system according to claim 15, wherein the ocular optical system further satisfies a following conditional expression: (EFL+TTL)/(T1+G12)≥5.500, wherein EFL is a system focal length of the ocular optical system, and TTL is a distance from the eye-side surface of the first lens element to the display screen on the optical axis.

20. The ocular optical system according to claim 15, wherein the ocular optical system further satisfies a following conditional expression: 4.300≤|OXR22/Sag22|≤6.200, wherein OXR22 is a maximum optical radius of the display-side surface of the second lens element, and Sag22 is a Sag value of the display-side surface of the second lens element on the maximum optical radius.
